(19) United States
(12) Patent Application Publication
(10) Pub. No.: US 2025/0321513 A1
(43) Pub. Date: Oct. 16, 2025

(54) DEVELOPING ROLLER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: KANA SATO, Shizuoka (JP); RYO SUGIYAMA, Shizuoka (JP); TAIJI KATSURA, Shizuoka (JP); KENTA MATSUNAGA, Shizuoka (JP); MASAHIRO WATANABE, Shizuoka (JP)

(21) Appl. No.: 19/170,350

(22) Filed: Apr. 4, 2025

(30) Foreign Application Priority Data
Apr. 11, 2024 (JP) 2024-064141

(51) Int. Cl. G03G 15/08; G03G 21/18

(52) U.S. Cl. CPC G03G 15/0818; G03G 21/18

(57) ABSTRACT

A developing roller includes a substrate that has a surface with conductivity and a conductive layer on the surface of the substrate, an outer surface of the developing roller is constituted by at least a first region and a second region that has a higher conductivity than the first region, the first region and the second region are disposed to be adjacent to each other, the first region includes at least one kind of polycarbonate, and the at least one kind of polycarbonate has a specific structure having a substituent in an aromatic ring of a main chain.

### BACKGROUND OF THE INVENTION

### Field of the Invention

The present disclosure relates to a developing roller, a process cartridge, and an electrophotographic image forming apparatus.

### Description of the Related Art

In recent years, there has been an increasing trend to require an increase in speed, an increase in durability, and energy saving in an electrophotographic image forming apparatus (electrophotographic apparatus), and reduction of a drive torque when the electrophotographic apparatus is driven has been required. A large proportion of the drive torque of an electrophotographic apparatus is due to a developing apparatus, and among others, the drive torque generated between a toner supply roller and a developing roller accounts for most of the drive torque. Therefore, energy saving can be achieved by reducing the drive torque between the toner supply roller and the developing roller.

In order to reduce the drive torque, the contact area of the toner supply roller with respect to the developing roller is reduced, or the peripheral speed difference between the developing roller and the toner supply roller is reduced, for example. However, if the contact area of the toner supply roller is reduced or the peripheral speed difference is reduced as described above, the amount of the toner supplied from the toner supply roller to the developing roller may become insufficient.

Japanese Patent Application Publication No. 2020-020958 discloses a developing roller which can attract a sufficient amount of toner even in a case where a drive torque is reduced by causing an insulating portion and a conductive portion to be present together in a minute area in the vicinity of the surface.

The developing roller disclosed in Japanese Patent Application Publication No. 2020-020958 has an insulating portion and a conductive portion caused to be present together in a minute area in the vicinity of the surface, and a sufficient amount of toner can be attracted even in a case where the drive torque is reduced by lowering a rotation speed of the toner supply roller and reducing the peripheral speed difference of the developing roller, for example. An embodiment using a polycarbonate having high durability in the insulating portion is disclosed.

### SUMMARY OF THE INVENTION

However, in a case where the developing roller disclosed in Japanese Patent Application Publication No. 2020-020958 is used, and the process speed is further increased, an image concentration may be degraded.

Therefore, the present disclosure provides a developing roller capable of suppressing decrease in concentration of an electrophotographic image over a long period of time even in a case where a drive torque between a toner supply roller and a developing roller is reduced and a process speed is increased. Also, the present disclosure provides a process cartridge and an electrophotographic image forming apparatus capable of stably forming an electrophotographic image with high quality.

The present disclosure relates to a developing roller comprising:
a substrate that comprises a surface with conductivity; and
a conductive layer on the surface of the substrate,
wherein an outer surface of the developing roller is constituted by at least a first region and a second region that has a higher conductivity than the first region,
the first region and the second region are disposed to be adjacent to each other,
the first region comprises at least one kind of polycarbonate, and
the at least one kind of polycarbonate comprises a structure represented by Formula (1A):

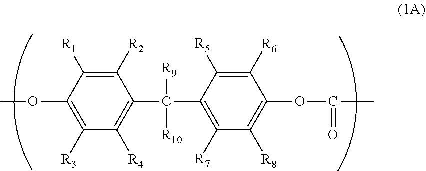

in Formula (1A),
R₁ to R₈ each independently represent a hydrogen atom, an alkyl group having 1 to 9 carbon atoms, or an aryl group having 6 to 10 carbon atoms,
R₉ and R₁₀ each independently represent a hydrogen atom, an alkyl group having 1 to 9 carbon atoms, or an aryl group having 6 to 10 carbon atoms, or
R₉ and R₁₀ are a group of atoms necessary for R₉ and R₁₀ to be bonded to each other to form an alicyclic structure having 6 to 12 carbon atoms, where (1A) satisfies at least one condition selected from a group consisting of Condition 1 and Condition 2 below:

### Condition 1

at least one selected from a group consisting of R₁ to R₈ is the alkyl group having 1 to 9 carbon atoms or the aryl group having 6 to 10 carbon atoms,

### Condition 2

at least one selected from a group consisting of R₉ and R₁₀ is a linear or branched alkyl group having 2 or more carbon atoms or the aryl group having 6 to 10 carbon atoms.

Further, the present disclosure relates to a process cartridge configured to be attachable to and detachable from a main body of an electrophotographic image forming apparatus,
the process cartridge comprising, at least: a developing means,
wherein the developing means comprises the aforementioned developing roller.

Further, the present disclosure relates to an electrophotographic image forming apparatus comprising:
a developing means,
wherein the developing means is the aforementioned developing roller.

According to the present disclosure, it is possible to obtain a developing roller capable of suppressing decrease in concentration of an electrophotographic image over a long period of time even in a case where a drive torque between a toner supply roller and a developing roller is reduced and a process speed is further increased. Also, according to the present disclosure, it is possible to obtain a process cartridge and an electrophotographic image forming apparatus capable of stably forming an electrophotographic image with high quality.

Further features of the present invention will become apparent from the following description of exemplary embodiments with reference to the attached drawings.

### BRIEF DESCRIPTION OF THE DRAWINGS

FIGS. 1A and 1B are schematic sectional views illustrating an example of a developing roller.

FIG. 2 is a schematic configuration diagram of an example of a process cartridge.

FIG. 3 is schematic sectional view of an example of an electrophotographic apparatus.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

In a general non-magnetic one-component developing method, firstly, a sufficient amount of toner in a developing device is supplied onto a developing roller by a toner supply roller. Next, the toner supplied onto the developing roller is regulated by a toner regulating member such as a developing blade. In this manner, the developing roller is coated with an appropriate amount of toner.

The developing roller according to Japanese Patent Application Publication No. 2020-020958 is a developing roller including a substrate having a surface with conductivity and a conductive layer on the surface of the substrate, an outer surface of the developing roller is constituted by at least an insulating portion and a conductive portion, and the insulating portion and the conductive portion are disposed to be adjacent to each other. The insulating portion on the surface of the developing roller is charged by being slid against an abutting member such as a developing blade or the toner at a position where it abuts on the abutting member by causing such a developing roller to be driven in the developing device. In this manner, a local potential difference occurs between the charged surface of the insulating portion and a non-charged surface of the conductive portion.

In a case where there is a local potential difference on the surface of the developing roller, an electric field gradient due to the potential difference occurs. In a case where an object is present in the electric field gradient, the object is polarized by the electric field gradient, and a gradient force is generated in a direction toward the surface of the developing roller. In other words, in a case where the toner is present in the vicinity of the developing roller having such a local potential difference on its surface, the developing roller can attract the toner to the surface of the developing roller itself. It is thus possible to form an image without causing decrease in concentration by the developing roller itself attracting the toner even in a case where the amount of toner supplied from the toner supply roller to the developing roller decreases due to reduction of the contact area of the toner supply roller with respect to the developing roller.

However, in a case where the process speed is increased in the developing roller disclosed in Japanese Patent Application Publication No. 2020-020958, the sliding time of the insulating portion with the abutting member and the toner is shortened when the insulating portion passes the abutting position, and the amount of charge of the insulating portion decreases. Therefore, it is considered that a local potential difference generated between the surface of the insulating portion and the conductive portion decreases, the gradient force decreases, the amount of toner attracted onto the developing roller is reduced, and the concentration decreases.

Furthermore, defects such as abrasion or cracking may occur in the surface of the insulating portion in a case where the developing roller is used over a long period of time. Therefore, the area of the insulating portion decreases, the amount of charge of the insulating portion decreases, and the gradient force decreases, for example. As a result, it is considered that the amount of attracted toner decreases and a concentration decreases.

Thus, the present inventors have continued studies by focusing on dielectric properties of an insulating portion and durability against abrasion, cracking, and the like from the viewpoint of obtaining a developing roller capable of suppressing decrease in image concentration even in a case where the process speed increases and the developing roller is used over a long period of time. As a result, the present inventors discovered that the developing roller having the following configuration suppresses decrease in concentration even in a case where the process speed is further increased and the developing roller is used over a long period of time.

The present disclosure relates to a developing roller comprising:
a substrate that comprises a surface with conductivity; and
a conductive layer on the surface of the substrate,
wherein an outer surface of the developing roller is constituted by at least a first region and a second region that has a higher conductivity than the first region,
the first region and the second region are disposed to be adjacent to each other,
the first region comprises at least one kind of polycarbonate, and
the at least one kind of polycarbonate comprises a structure represented by Formula (1A).

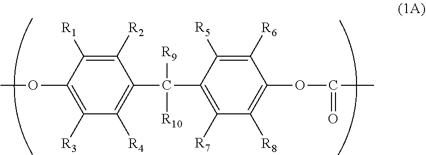

In Formula (1A),
R₁ to R₈ each independently represent a hydrogen atom, an alkyl group having 1 to 9 carbon atoms, or an aryl group having 6 to 10 carbon atoms,
R₉ and R₁₀ each independently represent a hydrogen atom, an alkyl group having 1 to 9 carbon atoms, or an aryl group having 6 to 10 carbon atoms, or
R₉ and R₁₀ are a group of atoms necessary for R₉ and R₁₀ to be bonded to each other to form an alicyclic structure having 6 to 12 carbon atoms,
where (1A) satisfies at least one condition selected from a group consisting of Condition 1 and Condition 2 below:

### Condition 1

at least one selected from a group consisting of R₁ to R₈ is the alkyl group having 1 to 9 carbon atoms or the aryl group having 6 to 10 carbon atoms,

### Condition 2

at least one selected from a group consisting of R₉ and R₁₀ is a linear or branched alkyl group having 2 or more carbon atoms or the aryl group having 6 to 10 carbon atoms.

The reason why the effects of suppressing decrease in image concentration and achieving durability by the first region (insulating portion) including polycarbonate are exhibited with such a structure is inferred to be as follows.

First, polycarbonate having the structure of Formula (1A) included in the first region has a benzene ring in a main chain, thus has high durability, and is excellent in durability against abrasion, cracking, and the like even in a case where the developing roller is used over a long period of time.

In addition, polycarbonate having the structure of Formula (1A) has steric hindrance in an aromatic ring of the main chain, and has less molecular orientation and higher molecular mobility than general polycarbonates. It is thus considered to be possible to suppress decrease in concentration even in a case where the process speed is further increased by using polycarbonate of Formula (1A).

The insulating portion is charged at an abutting position with an abutting member such as a developing blade. The abutting position has a width less than 1 mm, and a high electric field is applied thereto by blade bias or charge of the toner. In a case where the process speed is further increased, the insulating portion passes the abutting position in a short period of time, the sliding time of the insulating portion against the abutting member and the toner may thus be further shortened, and charging may become insufficient. Therefore, in a case where the process speed is further increased, it is necessary to charge the insulating portion in a short period of time, and it is thus considered to be necessary to achieve a state where a dielectric constant is high and charge exchange is likely to occur in the short period of time.

On the other hand, in order to cause a strong gradient force for attracting the toner to be expressed, it is necessary to cause the received charge to generate a large electric field, and the dielectric constant of the insulating portion is preferably low. Since the electric field does not externally act on the developing roller when the toner in a developing container is attracted, it is considered to be necessary that the dielectric constant be low in a case where the external electric field does not act thereon.

Here, a dielectric constant of a resin is strongly affected by molecular orientation, the dielectric constant is high when the molecular orientation is high, and the dielectric constant is low when the molecular orientation is low. On the basis of such circumstances, the present inventors inferred the dielectric constant depending on the molecular orientation in the structure of polycarbonate.

It is presumed that polycarbonate used in the present disclosure acts to relax an adhesive force of aromatic rings relative to conventional polycarbonate by providing steric hindrance around the aromatic ring, and polycarbonate used in the present disclosure has low crystallinity and less uniform molecular orientation as compared with conventional polycarbonate. Therefore, in a case where a high electric field is applied thereto for a short period of time, there are portions having high molecular mobility due to steric hindrance around the aromatic ring or the like, micro molecular orientation occurs in a part of the portions, and the dielectric constant is thus higher than that of conventional polycarbonate. On the other hand, in a case where there is no effects of an external electric field, polycarbonate used in the present disclosure has lower molecular orientation than conventional polycarbonate, and it is thus considered that the dielectric constant thereof is lower than that of conventional polycarbonate.

From the foregoing inference, the dielectric constant immediately after passing through the abutting position is higher than before in a case where the process speed is further increased by using polycarbonate of Formula (1A), a charge is thus more likely to be exchanged with the abutting member and the toner, and the insulating portion is sufficiently charged. Furthermore, since the dielectric constant when the external electric field after passing through the abutting position does not act is lower than before, it is considered to be possible to increase a gradient force and to attract a sufficient amount of toner.

In other words, steric hindrance is provided around the aromatic ring of the polycarbonate structure in the present disclosure. In this manner, it is possible to obtain a developing roller capable of suppressing decrease in image concentration even in a case where the developing roller is applied to an electrophotographic apparatus with a reduced drive torque and a further increased process speed and is used over a long period of time.

Hereinafter, the developing roller according to the present aspect will be described in detail.

### Developing Roller

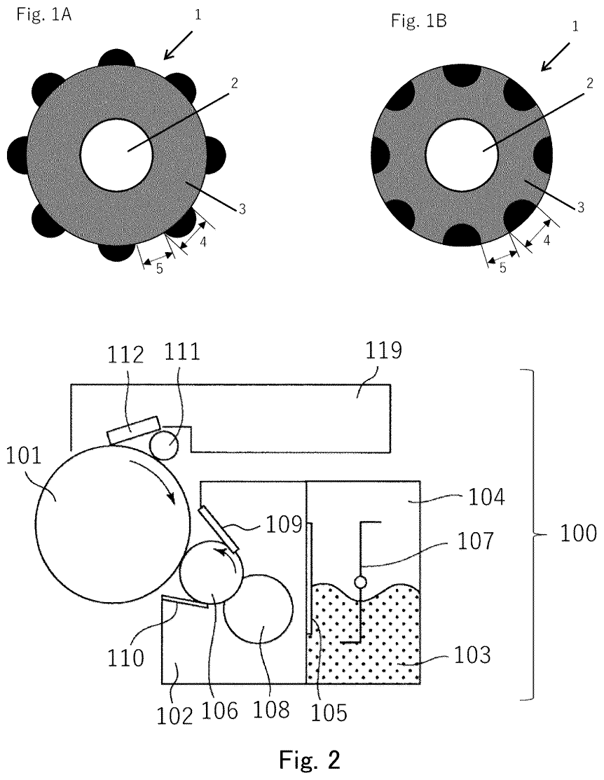

For the developing roller, a schematic sectional view when the developing roller is cut in a direction perpendicularly intersecting the longitudinal direction (axis direction) of the developing roller as illustrated in FIGS. 1A and 1B, for example, is exemplified as an example. Specifically, a developing roller 1 includes a substrate 2 with conductivity and a conductive layer 3 on the substrate as illustrated in FIG. 1A. Also, a configuration of the developing roller 1 in which first regions 4 (insulating portions) that are exposed from an outer surface (a surface on the side opposite to the surface on the side of the substrate) of the conductive layer 3 and second regions 5 (conductive portions) with higher conductivity than the first regions are present is exemplified. As illustrated in FIG. 1A, the first regions 4 may project from the outer surface of the developing roller, for example.

Also, the developing roller may be configured such that the first regions 4 are present inside the conductive layer 3 and the first regions 4 and the second regions 5 are exposed from the outer surface as illustrated in FIG. 1B. For example, the first regions 4 and the second regions 5 may form a substantially flat outer surface. In other words, it is only necessary for the developing roller that the second regions 5 be disposed on a part of the surface (outer surface) of the conductive layer 3 and the outer surface of the developing roller include at least the first regions 4 and the second regions 5 that are adjacent to each other. Note that the conductive layer 3 may be a single layer or include a plurality of layers.

### Substrate

The substrate has conductivity and has a function of supporting the conductive layer provided thereon. Examples of a material of the substrate include: metal such as iron, copper, aluminum, and nickel; and alloys such as stainless steel, duralumin, brass, and bronze containing these metals. One kind of these may be used, or two or more kinds may be used together. The surface of the substrate can be subjected to plating without damaging conductivity for the purpose of imparting scratch resistance. Furthermore, a substrate obtained by coating the surface of the substrate made of a resin with metal such that the surface has conductivity or a substrate manufactured from a conductive resin composition may also be used.

### Conductive Layer

In the developing roller, the conductive layer is disposed on the substrate and can have a one-layer structure or a stacked structure of two or more layers. In a non-magnetic one-component contact developing system process, in particular, a developing roller having two conductive layers is preferably used. Note that in a case where the developing roller includes a plurality of conductive layers, the content described below is preferably satisfied in regard to each conductive layer unless particularly stated otherwise.

The conductive layer can contain an elastic material such as a resin and a rubber. Specific examples of the resin and the rubber include a polyurethane resin, polyamide, a urea resin, polyimide, a melamine resin, a fluorine resin, a phenol resin, an alkyd resin, a silicone resins, polyester, ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, hydrogenated NBR, urethane rubber, and the like. One kind of these resins and rubbers can be used alone, or two or more kinds thereof may be used in combination as needed.

The second regions 5 preferably contain at least one selected from the group consisting of the resins and rubbers. Note that the materials of the resins and rubbers can be identified by measuring the conductive layers included in the developing roller using a Fourier transform infrared visible spectrophotometer.

Among the materials described above, the layer (lower layer) disposed closest to the side of the substrate side in the conductive layers preferably contains silicone rubber in a case where the conductive layers have a stacked structure.

Examples of the silicone rubber include polydimethyl siloxane, polymethyltrifluoropropyl siloxane, polymethylvinyl siloxane, polyphenylvinyl siloxane, and copolymers of these siloxanes.

Also, the layer (outermost layer) disposed on the side of the outermost surface in the conductive layers preferably contains a polyurethane resin. The polyurethane resin has excellent triboelectric charge performance to the toner and excellent flexibility, is thus easy to obtain a contact opportunity with the toner, has wear resistance, and is thus preferably used. The conductive layers preferably have a two-layer structure in which the layer (lower layer) disposed on the side of the substrate contains silicone rubber and the layer (outermost layer) disposed on the side of the outer surface in the conductive layers contains a polyurethane resin.

Examples of the polyurethane resin include an ether-based polyurethane resin, an ester-based polyurethane resin, an acrylic-based polyurethane resin, and a carbonate-based polyurethane resin. These polyurethane resins can be obtained by reactions of known polyols and isocyanate compounds.

Specific examples of polyols include polyether polyols such as polyethylene glycol, polypropylene glycol, and polytetramethylene ether glycol, polyester polyols such as polyethylene succinate diol, polybutylene succinate diol, polyethylene adipate diol, and polybutylene adipate diol, and polycarbonate polyols such as polyethylene carbonate diol and polybutylene carbonate diol.

Although the isocyanate components to be reacted with these polyol components are not particularly limited, examples thereof that can be used include aliphatic polyisocyanates such as ethylene diisocyanate, 1,6-hexamethylenediisocyanate (HDI), alicyclic polyisocyanates such as isophorone diisocyanate (IPDI), cyclohexane 1,3-diisocyanate, cyclohexane 1,4-diisocyanate, aromatic isocyanates such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, naphthalene diisocyanate, copolymers, isocyanurates, TMP adduct bodies, biuret bodies, and block bodies thereof. Among these, aromatic isocyanates such as tolylene diisocyanate, diphenylmethane diisocyanate, and polymeric diphenylmethane diisocyanate are more suitably used.

The conductive layers preferably contain a conductive agent in order to obtain conductivity. Examples of the conductive agent include an ion conductive agent and an electron conductive agent such as carbon black, and carbon black is preferably used because it is possible to control the conductivity of the conductive layers and the charge performance of the conductive layers with respect to the toner. Typically, the volume resistivity of the conductive layers is preferably in the range from 1.0×10³ Ω·cm to 1.0×10¹¹ Ω·cm. The volume resistivity of the conductive layers can be measured using a method similar to that of the volume resistivity of the first regions, which will be described later.

Specific examples of the carbon black include conductive carbon black such as “Ketjen Black” (a product name; manufactured by Lion Corporation) or acetylene black; and carbon black for rubber such as SAF, ISAF, HAF, FEF, GPF, SRF, FT, and MT. In addition, carbon black for color ink after being subjected to oxidation treatment or thermal decomposition carbon black can be used as the carbon black.

The amount of carbon black to be added is preferably from 5 parts by mass to 50 parts by mass with respect to 100 parts by mass of the total of the resin and the rubber in the conductive layers. The content of carbon black in the conductive layers can be measured using a thermogravimetric analyzer (TGA).

In addition to the above carbon black, the following conductive agents can be listed as conductive agents that can be used in the conductive layers: graphite such as natural graphite and artificial graphite; metal powder such as copper, nickel, iron, and aluminum; metal oxide powder such as titanium oxide, zinc oxide, tin oxide; conductive polymers such as polyaniline, polypyrrole, and polyacetylene. One kind of these can be used alone, or two or more kinds thereof can be used in combination as needed. Furthermore, the amount of these conductive agents to be added can be set as appropriate.

The conductive layers can additionally contain a charge control agent, a lubricant, a filler, an antioxidant, anti-aging agent, and the like without hindering the functions of the resin, the rubber, and the conductive agent described above. The amounts of these additives to be added can be set as appropriate.

The thickness of the conductive layers (total thickness in the case of the stacked structure) is preferably from 1 μm to 5 mm. The thickness of the conductive layers can be obtained by observing and measuring the sectional surface of the conductive layers when they are cut in the direction perpendicular to the axis direction of the developing roller with an optical microscope. In the case where the conductive layers have a two-layer structure, the thickness of the lower layer is preferably from 0.1 mm to 50.0 mm, and is more preferably from 0.5 mm to 10.0 mm. The thickness of the outermost layer is preferably from 4 μm to 100 μm and is more preferably from 6 μm to 30 μm.

In a case where the developing roller is required to have certain surface roughness, the conductive layers can contain a particle for controlling the roughness. In this case, the volume average particle size of the particle for controlling the roughness is preferably from 3 μm to 20 μm. The amount of the particle contained in the conductive layers is preferably from 1 part by mass to 50 parts by mass with respect to 100 parts by mass of the total of the resin and the rubber in the conductive layers. The content of the particle in the conductive layers can be measured using an analytical technique such as thermogravimetric analysis, for example.

Examples of the particle for controlling the roughness that can be used include fine particles of a polyurethane resin, a polyester resin, a polyether resin, a polyamide resin, an acrylic resin, and polycarbonate.

### First Regions

The first regions (hereinafter, also referred to as insulating portion) are disposed on and exposed from the outermost layer of the conductive layers. The first regions preferably cover a part of the outermost layer and constitute a part of the outer surface of the developing roller. The first regions may be, for example, present in a dotted pattern on the outer surface of the developing roller. The first regions may be connected to the extent that the conductive layers (second regions) of the developing roller are exposed.

### Material Constituting First Regions (Insulating Portions)

A material (an insulating material) constituting the insulating portions contains polycarbonate represented by Formula (1A) below. It is thus possible to suppress decrease in concentration of the electrophotographic image over a long period of time even in a case where a drive torque between the toner supply roller and the developing roller is reduced and the process speed is further increased.

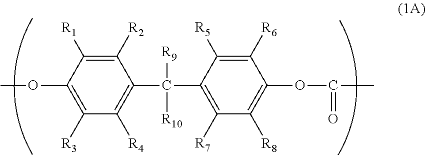

In Formula (1A),

R₁ to R₈ each independently represent a hydrogen atom, an alkyl group having 1 to 9 (preferably 1 to 4, or more preferably 1 to 3) carbon atoms, or an aryl group having 6 to 10 (preferably 6 to 8, or more preferably 6) carbon atoms.

R₉ and R₁₀ each independently represent a hydrogen atom, an alkyl group having 1 to 9 (preferably 1 to 4, or more preferably 1 to 3) carbon atoms, or an aryl group having 6 to 10 (preferably 6 to 8, or more preferably 6) carbon atoms, or R₉ and R₁₀ are a group of atoms necessary for R₉ and R₁₀ to be bonded to each other to form an alicyclic structure having 6 to 12 carbon atoms.

However, (1A) satisfies at least one condition selected from the group consisting of Condition 1 and Condition 2 below.

### Condition 1

At least one (preferably one to four, more preferably one to three, or further preferably two) selected from the group consisting of R₁ to R₈ is an alkyl group having 1 to 9 (preferably 1 to 4, or more preferably 1 to 3) carbon atoms or an aryl group having 6 to 10 (preferably 6 to 8, or more preferably 6) carbon atoms. Preferably, the remainders of R₁ to R₈ are hydrogen atoms.

### Condition 2

At least one selected from the group consisting of R₉ and R₁₀ is a linear or branched alkyl group having 2 or more (preferably 2 to 10, or more preferably 3 to 6) carbon atoms or an aryl group having 6 to 10 (preferably 6 to 8, or more preferably 6) carbon atoms. One of R₉ and R₁₀ preferably satisfies the above condition, and the other is preferably an alkyl group having 1 to 3 (preferably 1) carbon atoms.

Hereinafter, preferable polycarbonate will be described. Examples of polycarbonate include polycarbonate of Formula (1A) where at least one of R₁ and R₃ is the aforementioned alkyl group or aryl group and at least one of R₆ and R₈ is the aforementioned alkyl group or aryl group. At this time, the remainders of R₁ to R₈ are hydrogen atoms.

Also, polycarbonate of Formula (1A) where at least one of R₉ and R₁₀ is a linear or branched alkyl group having 1 to 9 (preferably 1 to 4) carbon atoms or unsubstituted phenyl group is exemplified. At this time, the remainder of R₉ and R₁₀ is a methyl group. Specifically, polycarbonate preferably contains at least one selected from the group consisting of Structural Formulae (1) to (3) below.

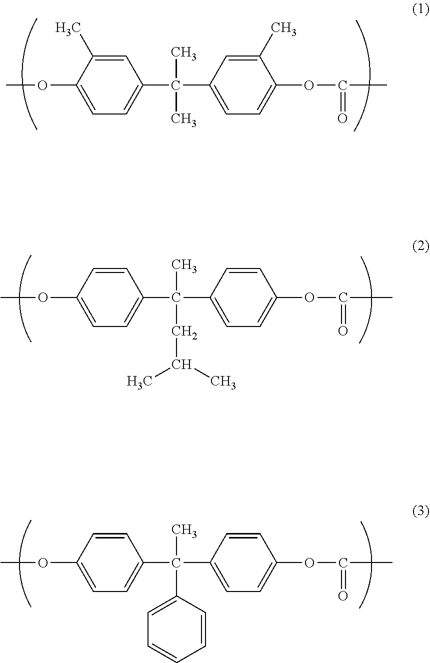

It becomes possible to achieve enhancement of micro molecular orientation in addition to excellent durability by polycarbonate containing Structural Formulae (1) to (3) above. As a result, it is possible to obtain a developing roller capable of further suppressing decrease in image concentration even in a case where the developing roller is applied to an electrophotographic image forming apparatus with a reduced drive torque and a further increased process speed and is used over a long period of time.

Also, polycarbonate preferably has at least one structure selected from the group consisting of the structure represented by Structural Formula (2) and the structure represented by Structural Formula (3) above. It is thus possible to relax the adhesive force between aromatic rings in the main chain and to enhance micro molecular orientation. As a result, it is possible to obtain a developing roller capable of further suppressing decrease in concentration in the electrophotographic image even in a case where the developing roller is applied to the electrophotographic image forming apparatus with a further increased process speed.

Furthermore, at least one kind of polycarbonate preferably includes first polycarbonate and second polycarbonate having mutually different structures. Also, the first polycarbonate preferably has the structure represented by Structural Formula (1), and the second polycarbonate preferably includes polycarbonate having at least one structure selected from the group consisting of the structure represented by Structural Formula (2) and the structure represented by Structural Formula (3).

With the aforementioned configuration, it is possible to further relax the adhesive force of the aromatic rings and to enhance micro molecular orientation. As a result, it is possible to obtain a developing roller capable of further suppressing decrease in concentration in the electrophotographic image even in a case where the developing roller is applied to the electrophotographic image forming apparatus with a further increased process speed.

Furthermore, it is preferable that the first polycarbonate further have a structure represented by Structural Formula (4). Also, it is preferable that the second polycarbonate further have the structure represented by Structural Formula (4).

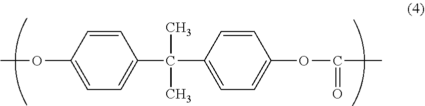

It is possible to obtain a developing roller with more excellent durability by having Structural Formula (4) in addition to the relaxing of the micro adhesive force by Structural Formulae (1) to (3).

Note that polycarbonate is preferably a copolymer from the viewpoint of durability.

Hereinafter, a method of synthesizing polycarbonate in this case will be described. For example, two methods will be described below. The first method is a method of causing one kind of bisphenol compound to react directly with phosgene (phosgene method). The second method is a method of causing a bisphenol compound to cause a transesterification reaction with bisallyl carbonate such as diphenyl carbonate, di-p-tolyl carbonate, phenyl-p-tolyl carbonate, di-p-chlorophenyl carbonate, or dinaphthyl carbonate (transesterification method).

In the phosgene method, the bisphenol compound is caused to react with phosgene typically in the presence of an acid binder and a solvent. Examples of the acid binder used at this time include pyridine and hydroxides of alkali metal such as potassium hydroxide and sodium hydroxide. Also, examples of the solvent include methylene chloride and chloroform. Furthermore, a catalyst or a molecular weight modifier may be added to promote a condensation polymerization reaction. Examples of the catalyst include tertiary amines such as triethylamine or quaternary ammonium salts. Examples of the molecular weight modifier include mono-functional group compounds such as phenol, p-cumylphenol, t-butylphenol, and long chain alkyl substituted phenol.

Also, when polycarbonate is synthesized, an antioxidant such as sodium sulfite or hydrosulfite; and a branching agent such as phloroglucin or isatin bisphenol may be used. Moreover, a reaction temperature when polycarbonate is synthesized is preferably 0° C. to 150° C. or is more preferably 5° C. to 40° C. A reaction time depends on the reaction temperature, is usually preferably 0.5 minutes to 10 hours, and is more preferably 1 minute to 2 hours. Also, pH of the reaction system is preferably set to 10 or more during the reaction.

As a material constituting the insulating portions, polycarbonate having the structure represented by Formula (1A) is preferably used. Note that the chemical structure of the material constituting the insulating portions can be specified through NMR analysis.

In this case, the weight average molecular weight (Mw) of polycarbonate is preferably 1000 to 800000, is more preferably 10000 to 100000, and is further preferably 50000 to 75000. Typically, as the number average molecular weight of polycarbonate decreases, the insulating portions are more likely to gather together when the insulating portions are formed on an elastic layer, and the insulating portions are thus more likely to have a bowl shape with a relatively high height. Furthermore, as the number average molecular weight of polycarbonate increases, polycarbonate is more likely to spread over the elastic layer and is more likely to have a branched shape with a low height. Therefore, the insulating portions covering a part of the elastic layer is easily formed by setting the number average molecular weight of polycarbonate within the above range, which is preferable.

The weight average molecular weight of the resin can be measured as follows.

### GPC

The molecular weight distribution of polycarbonate is measured as follows by gel permeation chromatography (GPC).

First, a sample is dissolved in tetrahydrofuran (THF) at room temperature for 24 hours. Then, the obtained solution is filtered through a solvent-resistant membrane filter “Mysyori Disc” (manufactured by Tosoh Corporation) with a pore size of 0.5 μm, thereby obtaining a sample solution. Note that the sample solution is prepared to have a concentration of 0.5% by mass. This sample solution is measured under the following conditions:
Apparatus: HLC-8320GPC (detector: RI) (manufactured by Tosoh Corporation)
Column: Shodex LF-404, LF-404 tandem (manufactured by Showa Denko K.K.)
Eluent: Tetrahydrofuran (THF)
Flow Rate: 0.4 ml/min
Oven temperature: 40.0° C.
Sample injection amount: 0.10 ml

To calculate the molecular weight of the sample, a molecular weight calibration curve created using a standard polystyrene resin (for example, a product name “Easi Vial PS-H polystyrene”; manufactured by Agilent Technology) is used.

The content of the structure represented by the Formula (1A) in at least one kind of polycarbonate is preferably 20 to 100 mol % on the basis of all structural units in polycarbonate. Also, the content of the structure represented by Formula (1A) is preferably 30 to 100 mol % on the basis of the total resin in the first region. Steric hindrance near the aromatic rings can relax a micro adhesive force, a desired dielectric constant can be achieved, and a sufficient amount of toner can be attracted by setting the content in this range. Note that the polycarbonate constituent unit is assumed to be —O—R—OCO— (R is an arbitrary group) in calculation of mol %.

Also, the content of the structure represented by Formula (1A) in at least one kind of polycarbonate is preferably 20 to 100% by mass, is more preferably 40 to 100% by mass, and is further preferably 50 to 90% by mass on the basis of the mass of polycarbonate. Moreover, the content of the structure represented by Formula (1A) is preferably 5 to 100% by mass and is more preferably 5 to 25% by mass on the basis of the total resin in the first region.

The content of the structure represented by Structural Formula (1) in polycarbonate is preferably 10 to 100% by mass, and is more preferably 20 to 70% by mass.

The content of the structure represented by Structural Formula (2) in polycarbonate is preferably 10 to 100% by mass, and is more preferably 20 to 70% by mass.

The content of the structure represented by Structural Formula (3) in polycarbonate is preferably 10 to 100% by mass, and is more preferably 20 to 70% by mass.

Polycarbonate preferably contains 0 to 80% by mass of the structure represented by Structural Formula (4) and more preferably contains 15 to 50% by mass of the structure represented by Structural Formula (4).

The content of each structure in polycarbonate can be analyzed by infrared absorption spectra and NMR.

### IR Analysis of Polycarbonate

ATR-IR analysis using polycarbonate is performed by the following method.

In IR analysis, a Fourier transform infrared spectrometer (Spectrum One: manufactured by PerkinElmer, Inc.) equipped with a universal ATR sampling accessory is used. Other conditions are as follows.

The incident angle of infrared light (2=5 μm) is set to 45°. As ATR crystal, an ATR crystal of Ge (refractive index=4.0) is used. Other conditions are as follows.

### Range

Start: 4000 cm⁻¹
End: 650 cm⁻¹ (Ge ATR crystal)

### Duration

Scan number: 16
Resolution: 4.00 cm⁻¹
   Advanced: with CO₂/H₂O correction
(1) Ge ATR crystal (refractive index=4.0) is attached to the apparatus.
(2) Scan type is set to Background, Units are set to EGY, and the background is measured.
(3) Scan type is set to Sample, and Units are set to A.
(4) 0.01 g of sample is weighed on the ATR crystal.
(5) The sample is pressurized with a pressure arm (Force Gauge is 90).
(6) The sample is measured.

### NMR Analysis of Polycarbonate

NMR analysis using polycarbonate is performed by the following method.

To 20 mg of sample, 1 g of deuteriochloroform (99.8 atom % D of chloroform-d containing 0.05% (v/v) TMS manufactured by Sigma-Aldrich Japan) was added and was then dissolved completely. This solution was transferred to a glass NMR sample tube (ST500-7 manufactured by Norell, Inc.) with an outer diameter of 5 mm, and proton NMR measurement was performed. AVANCE 500 from Bruker was used as an NMR apparatus. Other conditions are as follows.
The number of times of integration is 32.
Rotational speed is 20 Hz.

Automatic measurement by ICON-NMR was performed except for each set. In the resulting spectra, a chemical shift value of a peak of a methyl group of tetramethylsilane was corrected to 0 ppm.

Note that in order to confirm the polycarbonate structure of the insulating portions formed on the outer surface of the developing roller, the insulating portions of the developing roller were collected by using a micromanipulator (product name: Axis-Pro; manufactured by Micro Support Co., Ltd.), and aforementioned analysis was performed to confirm the polycarbonate structure.

The first regions (insulating portions) may contain polycarbonate alone or may contain a second resin listed below. Specific examples of the second resin include at least one selected from the group consisting of an acrylic resin, a polyolefin resin, an epoxy resin, and a polyester resin. It is preferable that the first regions further contain a (meth)acrylic resin, and it is more preferable that the first regions further contain an acrylic resin. The present inventors have inferred the reason why utilization of the second resin leads to a more satisfactory effect as follows.

Polycarbonate has steric hindrance in the aromatic rings of the main chain, has lower molecular orientation and higher molecular mobility than those of general polycarbonate. However, the micro adhesive force of the main chain of polycarbonate is strong, and in order to further improve the molecular mobility, relaxing of the aforementioned micro adhesive force is required. Here, the second resin forms a three-dimensional structure with a monomer having two or more functionalities, in particular. When the second resin is used, the second resin enters the main chains and contributes to the action of relaxing the micro adhesive force, and furthermore, the molecular orientation of the polycarbonate becomes uneven. Therefore, in a case where a high electric field is instantaneously applied, a part of the main chains themselves having high molecular mobility is formed and micro molecular orientation occurs in a part thereof in addition to steric hindrance around the aromatic rings, and the dielectric constant thus further increases.

From the aforementioned inference, the instantaneous dielectric constant at the time of passing through the abutting position further increases in a case where the process speed is further increased by using the second resin in addition to polycarbonate of Formula (1A), charge exchange with the abutting member and the toner becomes likely to occur, and the insulating portions are yet further sufficiently charged. Furthermore, since the dielectric constant when the external electric field is not applied after passing through the abutting position is low, it is considered to be possible to increase the gradient force and to attract a sufficient amount of toner.

Specific examples of the acrylic resin include at least one polymer selected from the group consisting of the following monomers: Polymers and copolymers of methyl methacrylate, 4-tert-butylcyclohexanol acrylate, stearyl acrylate, lauryl acrylate, 2-phenoxyethyl acrylate, isodecyl acrylate, isooctyl acrylate, isobornyl acrylate, 4-ethoxylated nonylphenol acrylate, isobornyl acrylate, ethoxylated bisphenol A diacrylate, and PO-modified Neopentyl glycol diacrylate.

The content of polycarbonate in the first regions is preferably 20 to 90% by mass and is more preferably 40 to 70% by mass on the basis of the total resin in the first regions.

The first regions may contain 10 to 80% by mass of second resin and more preferably contain 30 to 60% by mass of second resin, for example, on the basis of the total resin in the first regions.

Note that in a case where the first regions contain the second resin, it is possible to confirm the presence of the second resin through analysis of infrared absorption spectra.

### Volume Resistivity of First Regions

The volume resistivity of the first regions is preferably 1.0×10¹³ to 1.0×10¹⁸ Ω·cm and is more preferably 1.0×10¹⁴ to 1.0×10¹⁷ Ω·cm. If the volume resistivity of the first regions is within the above range, the first region is readily charged quickly.

The volume resistivity of the first regions can be controlled by the amount and crystallinity of polar groups in polycarbonate to be used and the second resin such as an acrylic resin used as needed.

### Confirmation of First Regions and Second Regions

First, it is confirmed that two or more regions are present on the outer surface of a member for electrophotography using an optical microscope or a scanning electron microscope, and the first regions and the second regions can thus be distinguished.

The first regions and the second regions can be regarded as a difference in reflectance intensity from a difference in a surface profile from the surface of the exposed portion. Also, the first regions and the second regions can be more clearly distinguished through a combination with an electrostatic force microscope (EFM) due to a difference in resistivity. For example, it is possible to use a digital microscope VHX-5000 (a product name; manufactured by Keyence Corporation) as an optical microscope, to use JSM-7800FPRIME (product name; manufactured by JEOL Ltd.) as an electron microscope, and to use MODEL 1100TN (a product name; manufactured by Trek Japan) as an electrostatic force microscope.

### Measurement of Volume Resistivity in First Regions

A sample was cut out from the developing roller, and a thin sample with a plane size of 50 μm square and a thickness t of 100 nm was made by a microtome. Next, this thin sample was placed on a metal flat plate, and the thin sample was pressed with a metal terminal having a pressing surface with an area S of 100 μm² from the upper side. In this state, 1 V of voltage was applied between the metal terminal and the metal flat plate with an electrometer (product name: 6517B, manufactured by KEITHLEY), thereby obtaining a resistance R. A volume resistivity pv was calculated from the resistance R using Expression (1) below.

$$p v = R \times S / t \qquad Expression ( 1 )$$

### Occupying Area of First Regions

In a case where the square observation region with a side length of 900 μm is placed on the outer surface of the developing roller such that the axis direction of the developing roller and one side of the observation region are parallel to each other, the proportion of the total area of the first regions (hereinafter, also referred to as an “occupancy rate RE”) in the area of the square region is preferably 10 to 60% by area. The occupancy rate RE is more preferably 20 to 50% by area and is further preferably 20 to 40% by area. It is possible to achieve a more satisfactory toner transporting force of the developing roller by setting the occupancy rate RE in the above range.

The occupancy rate RE can be controlled by wettability of a constituent material solution in the first regions, viscosity of the solution, a drying speed, surface roughness of the conductive layers, the solid content of the solution, and the like.

On the other hand, the proportion of the total area of the second regions to the area of the square region is preferably 40 to 90% by area, is more preferably 50 to 80% by area, and is further preferably 60 to 80% by area.

### Measurement of Occupancy Rate RE of First Regions

The occupancy rate RE of the first regions was measured as follows.

An objective lens with a magnification of 20 times was installed on a laser microscope (product name: VK-X100, manufactured by Keyence Corporation). Then, the surface of the developing roller was imaged in a total of nine regions, namely two locations at 10 mm inward from both end portions in the longitudinal direction, one location at the center, and three locations in the circumferential direction (at intervals of) 120°, and the captured images were connected such that one side had a length of 900 μm.

Next, tilt correction of the obtained observation image was performed in a quadratic curve correction mode. At the center of the corrected image, the area occupied by the first regions in a square area with a side length of 900 μm was measured. The measurement was performed using image processing software such as ImageJ. A value obtained by dividing the area occupied by the first regions by the square area with a side length of 900 μm was defined as the occupancy rate RE in the area. An arithmetic mean value was obtained from the obtained occupancy rates RE in the nine regions and was regarded as the occupancy rate RE of the developing roller 1.

Note that the first regions and the second regions were distinguished on the developing roller surface by the aforementioned procedure using the electron microscope and the electrostatic force microscope.

### Height of First Regions

An average value HD of the height of each of the plurality of first regions from the portions thereof in contact with the second region is preferably 0.1 to 15.0 μm and is more preferably 0.5 to 7.0 μm. It is possible to maintain durability against abrasion and cracking and to further attract the toner by setting the average value HD of the height to 0.1 μm or more. Rubbing between the insulating portions and the toner is likely to occur, and the insulating portions are more easily charged even in a case where the process speed is further increased, by setting the average value HD to 15.0 μm or less.

### Height Measurement of First Regions

For the height of the first regions, an objective lens having a magnification of 20 times is mounted on a laser microscope (product name: VK-8700; manufactured by Keyence Corporation), and the surface of the developing roller is observed. Then, tilt correction of the obtained observation image is performed. The tilt correction is performed in a quadratic curve correction mode. The corrected image is used to measure the first regions captured in the image. A difference “H2−H1” between the highest point H2 of the first regions and the height H1 of the conductive elastic layers (the contact portions between the first regions and the second regions) is calculated using the obtained three-dimensional observation image.

Note that the first regions and the second regions are distinguished by the aforementioned procedure using the electron microscope and the electrostatic force microscope.

Observation is performed at ten points (each location of each of ten regions obtained by equally dividing the developing roller in the longitudinal direction to 10 pieces) of the developing roller, and an arithmetic mean value of obtained “H2−H1” is defined as the average value HD of the heights of the first regions. At this time, all the first regions that are completely included in the square area with a side length of 300 μm are defined as measurement targets, and the first regions that are not completely included therein are not defined as measurement targets.

### Second Regions

The second regions are partial regions of the outer surface of the developing roller and are regions that are adjacent to the insulating portions and function as conductive portions with higher conductivity than the insulating portions. In the aspect illustrated in FIGS. 1A and 1B, a part of the conductive layer constituting the outer surface of the developing roller corresponds to the second regions.

Note that it is only necessary for the second regions to be present at (exposed from) a part of the outer surface of the developing roller, and the plurality of conductive portions may be present in a divided manner on the outer surface of the developing roller, or the plurality of conductive portions may be present in a connected manner (for example, as a series of conductive portions). However, (a series of) second regions are preferably disposed on the outer surface of the developing roller such that the second regions surround the plurality of first regions disposed at equal intervals on the outer surface of the developing roller from the viewpoint of uniformly transporting the toner.

The volume resistivity of the second regions is preferably 1.0×10⁵ to 1.0×10¹¹ Ω·cm and is more preferably 1.0×10⁵ to 1.0×10⁸ Ω·cm. If the volume resistivity of the second regions is within the above range, charges can be sufficiently removed. Note that the volume resistivity of the second regions can be measured similarly by selecting the second regions in the aforementioned measurement of the volume resistivity of the first regions.

The volume resistivity of the second regions can be controlled by the content or a dispersion state of the conductive agent, for example.

### Confirmation of First Regions and Second Regions

The presence of the first regions and the second regions in the developing roller can be confirmed by observing presence of two or more regions on the outer surface of the developing roller using an optical microscope, a scanning electron microscope, first.

Furthermore, the fact that the first regions have electrical insulating property and the fact that the second regions have higher conductivity than the first regions can be confirmed by causing the outer surface of the developing roller including the first regions and the second regions to be charged and then measuring a residual potential distribution.

The residual potential distribution can be confirmed by causing the outer surface of the developing roller to be sufficiently charged using a charging device such as a corona discharge device and then measuring the residual potential distribution on the charged outer surface of the developing roller using an electrostatic force microscope (EFM), a surface potential microscope (KFM), or the like, for example.

Also, the electrical insulating property of electrically insulating portions constituting the first regions and the conductivity of the conductive layer constituting the second regions can be evaluated by a time constant of the residual potential in addition to the volume resistivity. The time constant of the residual potential is a time required for the residual potential to be attenuated to the initial value 1/e and is an indication of how easily the charged potential can be held. Here, e is a bottom of a natural logarithm.

A potential attenuation time constant defined as a time required for the potential on the surface to be attenuated to V₀×(1/e) (V) when the surfaces of the first regions is charged to the potential of V₀ (V) is preferably 60.0 seconds or more and is more preferably 2000 to 5000 seconds. The time constant of the first regions is preferably 60.0 seconds or more because the first regions are quickly charged and the potential by the charging is easily held.

Furthermore, the potential attenuation time constant defined as a time required for the potential on the surface to be attenuated to V₀×(1/e) (V) when the surfaces of the second regions is charged to the potential of V₀ (V) is preferably less than 6.0 seconds and is more preferably less than a lower limit of measurement. The time constant of the second regions is preferably 6.0 seconds or less because charging of the second regions is suppressed, a potential difference is easily generated between the second regions and the charged first regions, and the gradient force is more easily expressed.

Note that in a case where the residual potential is approximately 0 V at the point of starting measurement by the following measurement method in measurement of the time constant, that is, in a case where the potential has completely been attenuated before the point of starting the measurement, the time constant at the measurement point is regarded to be less than 6.0 seconds. The time constant of the residual potential can be obtained by causing the outer surface of the developing roller to be sufficiently charged using a charging device such as a corona discharge device and then measuring temporal transition of the residual potentials in the first regions and the second regions on the charged outer surface of the developing roller using an electrostatic force microscope (EFM), for example.

### Observation of Outer Surface of Developing Roller

For the observation of the outer surface of the developing roller, an optical microscope (VHX5000 (product name), manufactured by Keyence Corporation) was used for the observation, and presence of two or more regions on the outer surface was confirmed.

### Measurement of Residual Potential Distribution

For measurement of the residual potential distribution, the outer surface of the developing roller on a thin piece, which will be described later, was corona-charged by a corona discharging device, and the residual potential distribution was obtained by measuring the residual potential of the outer surface by an electrostatic force microscope (MODEL 1100TN; manufactured by Trek Japan) while scanning the thin piece.

For production of the thin piece, a cryomicrotome (UC-6 (product name); manufactured by Leica Microsystems) was used to cut out a thin piece including the outer surface of the developing roller from the developing roller. The thin piece was cut out at a temperature of −150° C. such that the size of the outer surface of the developing roller was 100 μm×100 μm, the thickness with reference to the outer surface of the conductive layer was 1 μm, and two or more regions on the outer surface of the developing roller were included therein. The thin piece was placed on a smooth silicon wafer such that the surface including the outer surface of the developing roller faced up, and was left in an environment at a temperature of 23° C. and a relative humidity of 50% for 24 hours.

In the same environment, the silicon wafer with the thin piece placed thereon was mounted on a high-accuracy XY stage incorporated in the electrostatic force microscope. The corona discharging device with a distance of 8 mm between a wire and a grid electrode was used. The corona discharging device was disposed at a position where the distance between the grid electrode and the surface of the silicon wafer was 2 mm. The silicon wafer was then grounded, and a voltage of −5 kV was applied to the wire and a voltage of −0.5 kV was applied to the grid electrode using an external power source. After the start of the application, the high-accuracy XY stage was used to perform scanning at a speed of 20 mm/second in parallel to the silicon wafer surface such that the thin piece passed immediately below the corona discharging device, thereby corona-charging the outer surface of the developing roller on the thin piece.

Subsequently, the thin piece was caused to move to a location immediately below a cantilever of the electrostatic force microscope using the high-accuracy XY stage. Next, the residual potential of the corona-charged outer surface of the developing roller was measured while scanning was performed using the high-accuracy XY stage, thereby measuring the residual potential distribution. The measurement conditions are shown below.
Measurement environment: Temperature of 23° C., relative humidity of 50%
Time before starting measurement after measurement location passes immediately below corona discharging device: 60 seconds
Cantilever: cantilever for Model 1100TN (model number; Model 1100TNC-N; manufactured by Trek Japan)
Gap between measurement surface and cantilever tip: 10 μm
Measurement range: 99 μm×99 μm
Measurement interval: 3 μm×3 μm

Which of the electrically insulating first region and the second region having higher conductivity than the first region each region corresponded to was confirmed by confirming whether or not there were residual potentials of two or more regions present on the thin piece from the residual potential distribution obtained through the measurement. Specifically, regions that included locations where an absolute value of the residual potential was less than 1 V were regarded as the second regions, regions that included locations where an absolute value of the residual potential were larger than the absolute value of the residual potential of the second region by 1 V or more were regarded as the first regions from among the two or more regions, and the presence thereof was confirmed.

Note that the method of measuring the residual potential distribution was an example and may be changed to an apparatus and conditions suitable for confirming whether or not the residual potential of the two or more regions was present in accordance with the sizes, intervals, time constants, and the like of the first regions and the second regions.

### Measurement of Time Constant of Residual Potential

The time constant of the residual potential was obtained by corona-charging the outer surface of the developing roller by a corona discharging device, measuring temporal transition of the residual potential on the first region or the second region present on the outer surface by an electrostatic force microscope (MODEL 1100TN, Trek Japan), and fitting the result to Expression (1) below. Here, a point where the absolute value of the residual potential was the largest in the first regions confirmed through the measurement of the residual potential distribution was defined as a measurement point of the first regions. Also, a point where the residual potential was approximately 0 V in the second regions confirmed through the measurement of the residual potential was defined as a measurement point of the second regions.

First, the thin piece used to measure the residual potential distribution was placed on a smooth silicon wafer such that the surface including the outer surface of the developing roller faced upward, and was left for 24 hours in an environment at room temperature of 23° C. and a relative humidity of 50%.

Subsequently, the silicon wafer with the thin piece placed thereon was installed on a high-accuracy XY stage incorporated in the electrostatic force microscope in the same environment. The corona discharging device with a distance of 8 mm between a wire and a grid electrode was used. The corona discharging device was disposed at a position where the distance between the grid electrode and the surface of the silicon wafer was 2 mm. The silicon wafer was then grounded, and a voltage of −5 kV was applied to the wire and a voltage of −0.5 kV was applied to the grid electrode using an external power source. After the start of the application, scanning was performed at a speed of 20 mm/second in parallel to the surface of the silicon wafer such that the thin piece passed immediately below the corona discharging apparatus using the high-accuracy XY stage, thereby corona-charging the thin piece.

Subsequently, the measurement point of the first regions or the second regions was caused to move to a location immediately below the cantilever of the electrostatic force microscope using the high-accuracy XY stage, and temporal transition of the residual potential was measured. The electrostatic force microscope was used for the measurement. The measurement conditions are shown below.
Measurement environment: Temperature of 23° C., relative humidity of 50%
Time before starting measurement after measurement location passes immediately below corona discharging device: 15 seconds
Cantilever: cantilever for Model 1100TN (model number; Model 1100TNC-N; manufactured by Trek Japan)
Gap between measurement surface and cantilever tip: 10 μm
Measurement frequency: 6.25 Hz
Measurement time: 1000 seconds

The time constant t was obtained through fitting to Expression (1) below by the least squares method from the temporal transition of the residual potential obtained through the measurement.

$${V}_{0} = V ( t ) \times exp ( - t / τ ) \qquad ( 1 )$$

t: time (seconds) that has elapsed after measurement location passes immediately below corona discharging apparatus

$${V}_{0} : initial potential ( potential when t = 0 second ) ( V )$$

V(t): residual potential (V) at t seconds after measurement location passes immediately below corona discharging apparatus
τ: time constant (seconds) of residual potential

The time constant τ of the residual potential was measured at a total of nine points, namely three points in the longitudinal direction×three points in the circumferential direction on the outer surface of the developing roller, and an average value thereof was defined as the time constant of the residual potential of the first regions or the second regions according to the present invention. Note that in a case where a point where the residual potential became approximately 0 V was included at the time of starting the measurement, that is, at the time of 15 seconds after the corona charging in the measurement of the second regions, the time constant was defined as being less than the average value of the time constants at the remaining measurement points. Also, in a case where the potential at the time of starting the measurement was approximately 0 V at all the measurement points, the time constant was defined as being less than the lower limit of the measurement.

### Method of Forming First Regions and Second Regions

In a case where the conductive layers on the substrate with conductivity have a stacked structure, the conductive layer (outermost layer) to be disposed on the side of the outermost surface including the first regions and the second regions can be produced by the following method, for example, on the layer (lower layer) in the conductive layers disposed on the side closest to the substrate.

First, materials except for the resin for the first regions are used to form the outermost layer on the lower layer with conductivity (conductive layer forming process). Then, the insulating portions made of the resin for the first regions are formed on the surface of the conductive layers, and the conductive layer including the resins for the first regions and the second regions is formed (insulating portion forming process).

### Conductive Layer Forming Step

The lower layer with conductivity may be formed by a known method in accordance with the materials to be used.

Formation of the outermost layer will be described by exemplifying a urethane resin. Examples of a method of forming the outermost layer on the lower layer with conductivity include a method of coating the substrate with a coating solution obtained by mixing and dispersing a urethane resin, carbon black, a solvent, and the like with additives.

The solvent to be used in the coating solution can be appropriately selected under a condition that the urethane resin is dissolved (or dispersed). Specific examples of the solvent include: ketones represented by methyl ethyl ketone and methyl isobutyl ketone; hydrocarbons represented by hexane, toluene, and the like; alcohols represented by methanol and isopropanol; esters; and water. A particularly preferable solvent is methyl ethyl ketone or methyl isobutyl ketone from the viewpoint of solubility and a boiling point of the resin.

### First Region Forming Process

Although a method of forming the first regions that are to serve as insulating portions is not particularly limited, it is possible to use the following method, for example. In other words, examples thereof include a method of applying a material (insulating material) (before curing) such as polycarbonate constituting the first regions to the conductive layer in a dotted shape through screen printing or by a jet dispenser and as needed, curing (polymerizing) the material through heating or irradiation with ultraviolet light. The examples also include a method of applying the insulating material to the conductive layer through dipping, spraying, roll coating, or the like, intentionally causing the conductive layer to repel the insulating material, and then as needed, curing the insulating material through heating or irradiation with ultraviolet light.

In order to cause the conductive layer to repel the material forming the first regions, it is only necessary to coat (through spraying, dipping, or the like) the conductive layer with the constituent material solution of the first regions and to control wettability, viscosity of the solution, and a drying speed of the constituent material solutions of the first regions and the second regions, and surface roughness of the conductive layer, for example.

In a case where a second resin is used in addition to polycarbonate, it is also possible to use a method of dissolving an insulating material (before curing) containing a monomer of the second resin and polycarbonate in the solvent, applying the solution to the elastic layer by a method such as spraying, dipping, roll coating, or the like, and curing the solution through heating and/or irradiation with ultraviolet light as needed. Note that a drying operation can be performed as needed when the insulating portions are formed.

Note that the aforementioned insulating material can contain the materials constituting the aforementioned first regions (polycarbonate having the structure represented by Formula (1A), the second resin, and the like) and a solvent, which will be described later, and as needed, additives such as a polymerization initiator and the like.

Note that the solid content concentration (dilution concentration) of the insulating material is preferably 0.1 to 50% by mass and is more preferably 0.5 to 5% by mass from the viewpoint of forming the first regions on the conductive layer and also causing the second regions to be exposed from the surface.

Known polymerization initiators can be used as appropriate, and specifically, the following polymerization initiators can be used.

Examples of the polymerization initiator in a case of performing heating and polymerization include peroxides such as 3-hydroxy-1,1-dimethylbutylperoxyneodecanoate, α-cumylperoxyneodecanoate, t-butylperoxyneoheptanoate, t-butylperoxypivalate, t-amylperoxylnormaloctoate, t-butyl peroxy2-ethylhexylcarbonate, dicumylperoxide, di-t-butyl peroxide, di-t-amylperoxide, 1,1-di(t-butylperoxy)cyclohexane, n-butyl-4,4-di(t-butylperoxy) valerate; and azo compounds such as 2,2-azobisisobutyronitrile, 2,2-azobis(4-methoxy-2,4-dimethyvaleronitrile), 2,2-azobis(2,4-dimethylvaleronitrile), 2,2-azobis(2-methylbutyronitrile), 1,1-azobis(cyclohexane-1-carbonitrile), 2,2-azobis [2-(2-imidazoline-2-yl) propane], 2,2-azobis [2-methyl-N-(2-hydroxyethyl) propionamide], 2,2-azobis [N-(2-propenyl)-2-methylpropionamide], 2,2-azobis(N-butyl-2-methoxypropionamide), dimethyl-2,2-azobis(isobutylate).

Examples of the polymerization initiator in the case of performing irradiation with ultraviolet light and polymerization include 2,2-dimethoxy-1,2-diphenylethane-1-one, 1-hydroxycyclohexylphenyl ketone, 2-hydroxy-2-methyl-1-phenylpropane-1-one, 1-[4-(2-hydroxyethoxy)-phenyl]-2-hydroxy-2-methyl-1-propane-1-one, 2-hydroxy-1-{4-[4-(2-hydroxy-2-methyl-propionyl)-benzyl]-phenyl}-2-methylpropane-1-one, 2-methyl-1-[4-(methylthio)phenyl]-2-morpholinopropane-1-one, 2-benzyl-2-dimethylamino-1-(4-morpholinophenyl)-butan-1-one, 2-dimethylamino-2-(4-methylbenzyl)-1-(4-morpholine-4-yl-phenyl)-butane-1-one, bis(2,4,6-trimethylbenzoyl)-phenylphosphine oxide, and 2,4,6-trimethylbenzoyl-diphenylphosphine oxide.

Among these, 2-hydroxy-1-{4-[4-(2-hydroxy-2-methyl-propionyl)-benzyl]-phenyl}-2-methylpropane-1-one with a high surface hardening property is preferably used as an initiator because the surface curing is more likely to advance, crosslink density of the second resin increases, and durability can thus be further improved.

Note that one of these polymerization initiators may be used alone or two or more polymerization initiators may be used together. The blending amount of the polymerization initiator to be used is preferably from 0.5 parts by mass to 20 parts by mass from the viewpoint of causing the reaction to efficiently progress when the total amount of the compound (for example, a compound having a (meth)acryloyl group) for forming the second resin is defined as 100 parts by mass.

Note that a known heating apparatus and ultraviolet ray irradiation apparatus can be used as appropriate. Examples of the light source for irradiation with ultraviolet light that can be used include an LED lamp, a high-pressure mercury lamp, a metal halide lamp, a xenon lamp, and a low-pressure mercury lamp. The integrated amount of light required for polymerization can be appropriately adjusted depending on the types and the amounts of addition of the compound and the polymerization initiator to be used. The solvent used for the coating solution can be appropriately selected under a condition that an acrylic resin, a methacrylic resin, or the like is dissolved.

Specific examples of the solvent include: ketones represented by methyl ethyl ketone and methyl isobutyl ketone; hydrocarbons represented by hexane, toluene, and the like; alcohols represented by methanol and isopropanol; esters; and water. As a particularly preferable solvent, a low-boiling-point solvent such as methyl ethyl ketone is preferably used from the viewpoint that it is necessary to perform sufficient drying in a case where curing is achieved using ultraviolet light thereafter.

As a method of controlling the wettability of the surface of the conductive layer, it is possible to use a method of adding a surface adjusting agent, for example.

The developing roller according to the present aspect can also be applied to a non-contact type developing apparatus and a contact-type developing apparatus using a magnetic one-component developing agent or a non-magnetic one-component developing agent.

### Process Cartridge

A process cartridge according to the present aspect includes at least a developing means, and the developing means is characterized by including the developing roller according to the present aspect. FIG. 2 is a schematic sectional view of an example of the process cartridge according to an aspect of the present disclosure. The process cartridge is configured to be attachable to and detachable from a main body of an electrophotographic image forming apparatus and includes at least the developing means.

A process cartridge 100 illustrated in FIG. 2 is configured to be attachable to and detachable from the main body of the electrophotographic apparatus. The process cartridge 100 includes a developing chamber 102 as the developing means that includes an opening portion at a part facing an electrophotographic photoreceptor 101, and a toner container 104 that accommodates a toner 103 is disposed on a rear surface of the developing chamber 102. A transport member 107 for transporting the toner 103 to the developing chamber 102 is disposed in the toner container 104 as needed. An opening that establishes communication between the developing chamber 102 and the toner container 104 is partitioned by a sealing member 105, and the sealing member 105 is removed at the time of starting utilization of the process cartridge 100. Also, the developing chamber 102 is provided with a developing roller 106, a toner supply roller 108, a developing blade 109, and a toner splashing prevention sheet 110. The aforementioned developing roller can be used as the developing roller 106. The toner 103 is applied to the developing roller 106 by the toner supply roller 108. The developing roller 106 is rotated in the direction indicated by the arrow in the drawing, and the toner 103 carried on the developing roller 106 is regulated to a predetermined layer thickness by the developing blade 109 and is then sent to a developing region facing the electrophotographic photoreceptor 101.

In addition to the aforementioned configuration, the process cartridge 100 includes a charging roller 111, a cleaning blade 112, and a waste toner container 119.

### Electrophotographic Image Forming Apparatus

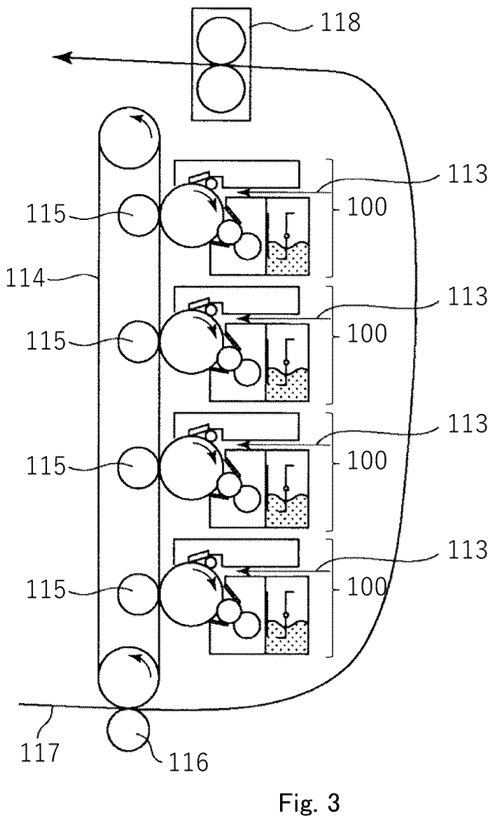

An electrophotographic image forming apparatus (electrophotographic apparatus) according to the present aspect includes a developing means, and the developing means is characterized by including the developing roller according to the present aspect. FIG. 3 is a schematic sectional view of an example of the electrophotographic apparatus. The electrophotographic apparatus can be used by attaching the process cartridge 100 illustrated in FIG. 2. The developing means is the aforementioned developing chamber 102.

Hereinafter, a print operation of the electrophotographic apparatus will be described. The electrophotographic photoreceptor 101 is uniformly charged by the charging roller 111 connected to a bias power source (not illustrated). Next, an electrostatic latent image is formed on the surface of the electrophotographic photoreceptor 101 with exposure light 113 for writing the electrostatic latent image. Any of LED light and laser light can be used as the exposure light 113.

Next, a toner charged to have negative polarity is applied to (developed on) the electrostatic latent image by the developing roller 106 incorporated in the process cartridge 100 that is configured to be attachable to and detachable from the electrophotographic apparatus main body. Then, a toner image is formed on the electrophotographic photoreceptor 101, and the electrostatic latent image is transformed into a visible image. At this time, a bias power source (not illustrated) applies a voltage to the developing roller 106.

The toner image developed on the electrophotographic photoreceptor 101 is primarily transferred to an intermediate transfer belt 114. A primary transfer member 115 abuts on a rear surface of the intermediate transfer belt 114, and the toner image with negative polarity is primarily transferred from the electrophotographic photoreceptor 101 to the intermediate transfer belt 114 by applying a voltage to the primary transfer member 115. The primary transfer member 115 may have a roller shape or may have a blade shape.

In the electrophotographic apparatus illustrated in FIG. 3, a total of four process cartridges 100 each incorporating a toner of each of a yellow color, a cyan color, a magenta color, and a black color are attached in a state where the process cartridges 100 are attachable to and detachable from the main body of the electrophotographic apparatus. Then, the aforementioned processes of charging, exposure, developing, and primary transfer are sequentially executed with a predetermined time difference, and a state where toner images of four colors for expressing a full-color image are superimposed on the intermediate transfer belt 114 is produced.

The toner image on the intermediate transfer belt 114 is transported to a position facing a secondary transfer member 116 with rotation of the intermediate transfer belt 114. Until this time, a recording sheet that is a transfer material has been transported between the intermediate transfer belt 114 and the secondary transfer member 116 along a transport route 117 for the recording sheet at a predetermined timing. Then, a secondary transfer bias is applied to the secondary transfer member 116, thereby transferring the toner image on the intermediate transfer belt 114 to the recording sheet.

The recording sheet onto which the toner image has been transferred by the secondary transfer member 116 is transported to a fixing device 118, the toner image on the recording sheet is melted and fixed on the recording sheet, the recording sheet is discharged to the outside of the electrophotographic apparatus, and the print operation then ends. Note that the toner image remaining on the electrophotographic photoreceptor 101 without being transferred from the electrophotographic photoreceptor 101 to the intermediate transfer belt 114 is scraped off by a cleaning blade 112 and is then accommodated in the waste toner accommodating container 119.

### EXAMPLES

Although examples of the present disclosure and comparative examples will be described below, the present disclosure is not limited to these.

### Synthesis of Polycarbonate

Polycarbonate was synthesized as follows.

### Synthesis Example 1 of Polycarbonate

To 1100 ml of a 5% by mass aqueous sodium hydroxide solution, 42.5 g of 2,2-bis(4-hydroxyphenyl) propane (manufactured by Tokyo Chemical Industry Co., Ltd., product code B0494), 37.5 g of 2,2-bis(3-methyl-4-hydroxyphenyl) propane (manufactured by Tokyo Chemical Industry Co., Ltd., product code B1567), and 0.1 g of hydrosulfite were dissolved. To this mixture, 500 ml of methylene chloride was added and stirred, and 60 g phosgene was then blown thereinto in 60 minutes while the mixture was kept at 15° C.

After the blowing of the phosgene ended, 1.3 g of p-t-butylphenol (hereinafter, abbreviated as “PTBP”; manufactured by Tokyo Chemical Industry Co., Ltd., product code: B0383) was added thereto as a molecular weight modifier and was stirred to thereby emulsify the reaction solution. After emulsifying, 0.4 ml of triethylamine was added thereto and was stirred at 23° C. for 1 hour to thereby cause polymerization.

After the polymerization ended, the reaction solution was separated into an aqueous phase and an organic phase, the organic phase was neutralized with a phosphoric acid, and washing with water was repeated until the conductivity of the washing solution (aqueous phase) became 10 μS/cm or less. The obtained polymer solution was added dropwise to warm water kept at 45° C., and the solvent was evaporated and removed to thereby obtain a white powder precipitate. The obtained precipitate was filtered and dried at 110° C. for 24 hours to thereby obtain polycarbonate (PC-1). The molecular weight Mw of this polycarbonate measured by GPC was 56000. A measurement method by the GPC was as described above.

Then, for the obtained polycarbonate, the fact that the structure of polycarbonate was constituted by Structural Formulae (1) and (4) was confirmed through analysis of IR and NMR. Note that the IR and NMR analysis was performed as described above.

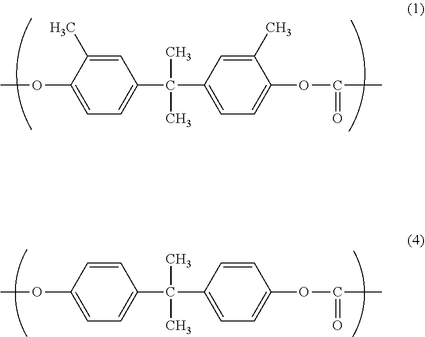

### Synthesis Examples 2 to 17 of Polycarbonate

PC-2 to PC-17 were obtained as in Table 2 similarly to Synthesis Example 1 of polycarbonate other than that materials and blending ratios shown in Table 1 below were adopted.

Note that the used materials 1 to 5 described in Table 1 were as follows:
Material 1:2,2-bis(4-hydroxyphenyl) propane (corresponding to Structural Formula (4))
(product name: manufactured by Tokyo Chemical Industry Co., Ltd., product code B0494)
Material 2:2,2-bis(3-methyl-4-hydroxyphenyl) propane (corresponding to Structural Formula (1))
(product name: manufactured by Tokyo Chemical Industry Co., Ltd., product code B1567)
Material 3:1,1-bis(4-hydroxyphenyl)-1-phenylethane (corresponding to Structural Formula (3))
(product name: manufactured by Tokyo Chemical Industry Co., Ltd., product code M1098)
Material 4:2,2-bis(4-hydroxyphenyl)-4-methylpentane (corresponding to Structural Formula (2))
(product name: manufactured by Tokyo Chemical Industry Co., Ltd., product code D3267)
Material 5:4,4′-dihydroxybiphenyl (corresponding to Structural Formula (5))
(product name: manufactured by Tokyo Chemical Industry Co., Ltd., product code B0464)

TABLE 1

| Material name | PC-1 | PC-2 | PC-3 | PC-4 | PC-5 | PC-6 | PC-7 | PC-8 | PC-9 |
|---|---|---|---|---|---|---|---|---|---|
| Material 1 | 42.5 | — | — | — | — | — | 31.8 | 21.1 | 62.5 |
| Material 2 | 37.5 | — | 37.3 | 50.9 | — | 16.3 | 24.3 | 19.8 | 17.5 |
| Material 3 | — | 45.8 | — | — | 32.0 | 40.3 | 23.9 | 22.4 | — |
| Material 4 | — | 34.2 | 42.7 | — | — | 23.4 | — | 16.7 | — |
| Material 5 | — | — | — | 29.1 | 48.0 | — | — | — | — |

| Material name | PC-10 | PC-11 | PC-12 | PC-13 | PC-14 | PC-15 | PC-16 | PC-17 |
|---|---|---|---|---|---|---|---|---|
| Material 1 | 60.7 | 61.7 | 32.4 | 41.4 | — | — | — | 72.0 |
| Material 2 | — | — | 24.8 | — | 80.8 | — | — | — |
| Material 3 | 19.3 | — | — | — | — | 91.5 | — | — |
| Material 4 | — | 18.3 | 22.7 | 38.6 | — | — | 85.2 | — |
| Material 5 | — | — | — | — | — | — | — | — |

A unit of the numerical value for each material is g.

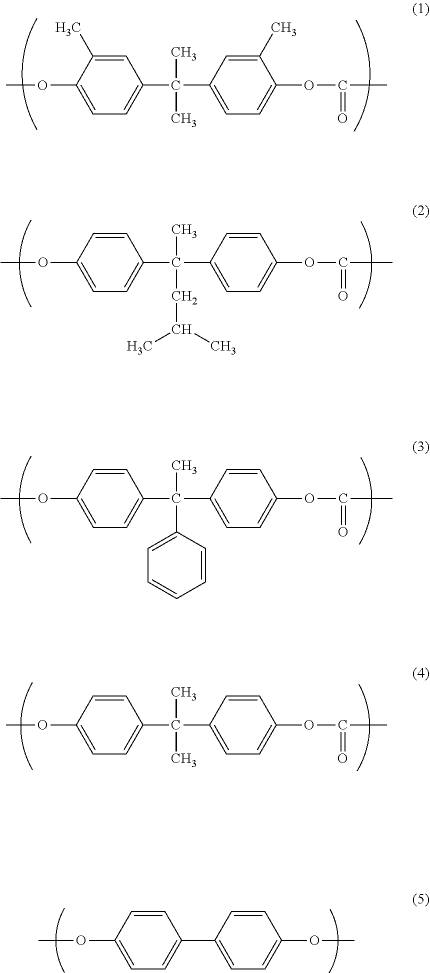

TABLE 2

| Material | PC- | PC- | PC- | PC- | PC- | PC- | PC- | PC- | PC- | PC- | PC- | PC- | PC- | PC- | PC- | PC- | PC- |
|---|---|---|---|---|---|---|---|---|---|---|---|---|---|---|---|---|---|
| name | 1 | 2 | 3 | 4 | 5 | 6 | 7 | 8 | 9 | 10 | 11 | 12 | 13 | 14 | 15 | 16 | 17 |
| Structure | 0.4 | — | 0.5 | 0.6 | — | 0.2 | 0.3 | 0.3 | 0.2 | — | — | 0.3 | — | 1.0 | — | — | — |
| Formula (1) | | | | | | | | | | | | | | | | | |
| Structure | — | 0.5 | 0.5 | — | — | 0.3 | — | 0.2 | — | — | 0.2 | 0.3 | 0.4 | — | — | 1.0 | — |
| Formula (2) | | | | | | | | | | | | | | | | | |
| Structure | — | 0.5 | — | — | 0.3 | 0.5 | 0.3 | 0.3 | — | 0.2 | — | — | — | — | 1.0 | — | — |
| Formula (3) | | | | | | | | | | | | | | | | | |
| Structure | 0.6 | — | — | — | — | — | 0.4 | 0.3 | 0.8 | 0.8 | 0.8 | 0.4 | 0.6 | — | — | — | 1.0 |
| Formula (4) | | | | | | | | | | | | | | | | | |
| Structure | — | — | — | 0.4 | 0.7 | — | — | — | — | — | — | — | — | — | — | — | — |
| Formula (5) | | | | | | | | | | | | | | | | | |

The numerical values in Table 2 each show the molar ratio of each structural formula.

### Example 1

### Formation of First Conductive Layer

A conductive substrate was prepared by coating a core metal made of stainless steel: SUS304 and having a diameter of 6 mm with a primer (product name “DY39-012”; manufactured by Dow Corning Toray CO. Ltd.) to a thickness of 10 μm, putting the resulting object into a hot air vulcanization furnace at 150° C. for 15 minutes, and baking the resulting object. This shaft core was positioned in a mold, and an additional silicone rubber composition obtained by mixing the materials shown in Table 3 below was injected into a cavity formed in the mold.

TABLE 3

| | Parts |
|---|---|
| Material of additive silicone rubber composition | by mass |
| Liquid-form silicone rubber material | 100 |
| (product name “SE6905A/B”; manufactured | |
| by Dow Corning Toray Co. Ltd.) | |
| Carbon black | 5 |
| (product name “Denka Black, powder product”; | |
| manufactured by Denka Company Ltd.) | |

Subsequently, the mold was heated to vulcanize and cure the additional silicone rubber composition at a temperature of 130° C. for 5 minutes, and the additional silicone rubber composition was removed from the mold. Thereafter, the additional silicone rubber was further heated at a temperature of 180° C. for 1 hour to complete the curing reaction of the silicone rubber layer, thereby manufacturing an elastic roller including a first conductive layer with a thickness of 3 mm at the outer periphery of the substrate.

### Formation of Second Conductive Layer

Next, the materials shown in Table 4 below were mixed, methyl ethyl ketone was added thereto such that the total solid content ratio became 30% by mass, and the mixture was then mixed with a sand mill. Then, a coating solution was prepared by adjusting the viscosity to 10 to 12 cps (mPa's) with methyl ethyl ketone.

TABLE 4

| | Parts |
|---|---|
| Material | by mass |
| Polytetramethylene ether glycol | 100 |
| (product name: PTMG2000, manufactured | |
| by Mitsubishi Chemical Group) | |
| Polymeric MDI | 20 |
| (product name: Millionate MR-200, | |
| manufactured by Tosoh Corporation) | |
| Carbon black | 30 |
| (product name: MA100, manufactured | |
| by Mitsubishi Chemical Group) | |
| Urethane resin fine particle | 20 |
| (product name: Art Pearl C-400, manufactured | |
| by Negami Chemical Industrial Co., Ltd.) | |
| Polyether-modified silicone oil | 1 |
| (product name: TSF4445, manufactured | |
| by Momentive Performance Materials) | |

This coating solution was applied to the elastic roller by a dipping method such that the film thickness became 10 μm. In the dipping method, the elastic roller was immersed in the coating solution by holding an upper end of the substrate with the longitudinal direction of the developing roller set to the vertical direction. The obtained coated object was dried at room temperature (23° C.) for 30 minutes, and a curing reaction was then caused in 2 hours in an oven at a temperature of 150° C., thereby manufacturing a urethane roller including a second conductive layer on the outer peripheral surface of the first conductive layer. The surface of the urethane roller may form the second regions.

### Formation of First Regions

Polycarbonate (PC-1) was dispersed in MEK and applied onto the outer peripheral surface of the urethane roller. The first regions were thus formed on the outer peripheral surface.

Specifically, 20 parts by mass of polycarbonate (PC-1) was weighed, MEK was added thereto such that the concentration of an insulating resin forming compound forming the first regions became 2% by mass, and the well-dissolved mixture was placed in an overflow type circulating coating apparatus. After the urethane roller was immersed in the coating apparatus and was pulled up, air drying was performed for 40 minutes, and the urethane roller was then heated at 90° C. for 1 hour, thereby producing the developing roller 1. Note that at this time, the first regions were applied in a state where the first regions were repelled on the conductive layer.

### Confirmation of First Regions and Second Regions

The presence of the first regions and the second regions on the outer surface of the developing roller 1 was confirmed as described above. The ratios of the area occupied by the first regions and the second regions in the outer surface area of the obtained developing roller were 30% and 70%, respectively.

### Analysis of Insulating Portions

For confirmation of the chemical structure of the insulating portions, it was confirmed that polycarbonate was constituted by Structural Formulae (1) and (4) by performing IR and NMR analysis as described above.

### Resistance Measurement of Insulating Portions

The volume resistivity was confirmed as described above and was 2.8×10¹⁴ Ω·cm.

### Resistance Measurement of Conductive Portions

The volume resistivity was confirmed as described above and was 7.2×10⁶ Ω·cm.

### Time Constant of First Regions (Insulating Portions)

The time constant was confirmed as described above and was 2958.0 sec.

### Time Constant of Second Regions (Conductive Portions)

The time constant was confirmed as described above and was below the lower limit of measurement.

### Height of First Regions (Insulating Portions)

The height of the first regions (insulating portions) was confirmed as described above and was 5.5 μm.

### Evaluation of Images

First, a gear of the toner supply roller was removed from a commercially available toner cartridge 318 (cyan) (manufactured by Canon Inc.) for the process cartridge for the purpose of reducing a torque of the produced developing roller. The torque of the toner supply roller decreases relative to the developing roller by removing the gear, and the amount of toner scraped off from the developing roller decreases.

Next, the produced developing roller 1 was assembled with the process cartridge, and the process cartridge was loaded on LBP-7600C (manufactured by Canon Inc.), which was a commercially available laser printer. This laser beam printer was left in an environment at a temperature of 23° C. and relative humidity of 50% for 24 hours.

Next, one full-surface solid image was output in the same environment, and outputting of 20000 images at a printing rate of 0.2% was then repeated 25 times to output one full-surface solid image (normal time).

Furthermore, the aforementioned electrophotographic image forming apparatus was modified such that outputting can be performed at a speed of 50 A4 sheets/min, one full-surface solid image was output in the same environment, and outputting of 20000 images at a printing rate of 0.2% was then repeated 25 times, thereby outputting one full-surface solid image (50 sheets/min).

Thereafter, the image concentrations of a total of 26 full-surface solid images obtained were measured using a spectrophotometer: X-Rite504 (product name, SDG K.K,) under each of the conditions (normal time) and (50 sheets/min). Note that an average value obtained by performing measurement at 15 points per full-surface solid image was regarded as each image concentration. The image concentrations according to the numbers of output sheets were compared, and evaluation was performed on the basis of the following evaluation criteria 1 and 2. Note that the evaluation criterion 1 was for evaluation of the images output under the condition of the normal time. The results are shown in Tables 6-1 and 6-2. Hereinafter, the image concentration of the first output solid image will be referred to as an “image concentration of the first sheet”, and the image concentration of the solid image output in the X-th process will be referred to as an “image concentration of the X-th sheet”.

### Evaluation Criterion 1

S: A difference between the image concentration of the first sheet and the image concentration of the twentieth sheet was less than 0.1, and a difference between the image concentration of the first sheet and the image concentration of the twenty sixth sheet was less than 0.1.
A: The difference between the image concentration of the first sheet and the image concentration of the twentieth sheet was less than 0.1, and the difference between the image concentration of the first sheet and the image concentration of the twenty sixth sheet was 0.1 or more.
B: The difference between the image concentration of the first sheet and the image concentration of the twentieth sheet was 0.1 or more and less than 0.2, and the difference between the image concentration of the first sheet and the image concentration of the twenty sixth sheet was less than 0.2.
C: The difference between the image concentration of the first sheet and the image concentration of the twentieth sheet was 0.1 or more and less than 0.2, and the difference between the image concentration of the first sheet and the image concentration of the twenty sixth sheet was 0.2 or more.
D: The difference between the image concentration of the first sheet and the image concentration of the twentieth sheet was 0.2 or more and less than 0.3.
E: The difference between the image concentration of the first sheet and the image concentration of the twentieth sheet was 0.3 or more.

### Evaluation Criterion 2

S: A difference between the image concentration of the twentieth sheet at the normal time and the image concentration of the twentieth sheet at the time of outputting at a speed of 50 sheets/min was less than 0.1, and a difference between the image concentration of the twenty sixth sheet at the normal time and the image concentration of the twenty sixth sheet at the time of outputting at a speed of 50 sheets/min was less than 0.1.
A: The difference between the image concentration of the twentieth sheet at the normal time and the image concentration of the twentieth sheet at the time of outputting at a speed of 50 sheets/min was less than 0.1, and the difference between the image concentration of the twenty sixth sheet at the normal time and the image concentration of the twenty sixth sheet at the time of outputting at a speed of 50 sheets/min was 0.1 or more.
B: The difference between the image concentration of the twentieth sheet at the normal time and the image concentration of the twentieth sheet at the time of outputting at a speed of 50 sheets/min was 0.1 or more and less than 0.2, and the difference between the image concentration of the twenty sixth sheet at the normal time and the image concentration of the twenty sixth sheet at the time of outputting at a speed of 50 sheets/min was less than 0.2.
C: The difference between the image concentration of the twentieth sheet at the normal time and the image concentration of the twentieth sheet at the time of outputting at a speed of 50 sheets/min was 0.1 or more and less than 0.2, and the difference between the image concentration of the twenty sixth sheet at the normal time and the image concentration of the twenty sixth sheet at the time of outputting at a speed of 50 sheets/min was 0.2 or more.
D: The difference between the image concentration of the twentieth sheet at the normal time and the image concentration of the twentieth sheet at the time of outputting at a speed of 50 sheets/min was 0.2 or more and less than 0.3.
E: The difference between the image concentration of the twentieth sheet at the normal time and the image concentration of the twentieth sheet at the time of outputting at a speed of 50 sheets/min was 0.3 or more.

### Examples 2 to 33 and Comparative Examples 1 and 2

Developing rollers 2 to 35 in Examples 2 to 33 and Comparative Examples 1 and 2 were produced similarly to Example 1 other than that the materials used for insulating resin forming compounds forming the first regions and the amounts of used materials were changed as in Table 5 below. The obtained developing rollers 2 to 35 were evaluated similarly to Example 1. The results are shown in Tables 6-1 and 6-2.

However, a molecular weight modifier PTBP was added as follows in the following examples. In Example 30, 1.0 g of molecular weight modifier PTBP was added. In Example 31, 1.2 g of molecular weight modifier PTBP was added.

Also, in Examples 5 to 8, 11, 12, 14, 16, 19, 21, 23, 25, and 29 and Comparative Example 1, the insulating portions were formed as follows.

Specifically, each of the materials (parts by mass) shown in Table 5 was weighed, MEK was added thereto such that the concentration of the insulating resin forming compound forming the first regions became 2% by mass, and the well-dissolved mixture was placed into an overflow type circulating coating apparatus. The urethane roller was immersed in the coating apparatus and was then pulled up, air drying was performed for 40 minutes, and heating was then performed at 90° C. for 1 hour. Note that the components forming the first regions had been applied in a splashed state onto the conductive layers until this time.

Thereafter, the outer surface of the urethane roller with the mixture was caused to adhere thereto was irradiated with ultraviolet light such that the cumulative light quantity became 2000 mJ/cm² to cure the components forming the first regions, thereby forming the first regions. Thus, the developing rollers according to these examples were produced. Note that a high-pressure mercury lamp (product name: handy-type UV curing apparatus; manufactured by Marionetwork) was used as the ultraviolet irradiation apparatus.

Note that in Examples 1 to 33, the first regions and the second regions were disposed to be adjacent to each other and the first regions were present in a dotted pattern.

Comparative Examples 1 and 2 were examples in which the structure represented by Formula (1A) was not included.

TABLE 5

| | | Example No. | | | | | | | | | | | | | | | | | |
|---|---|---|---|---|---|---|---|---|---|---|---|---|---|---|---|---|---|---|---|
| Material | | 1 | 2 | 3 | 4 | 5 | 6 | 7 | 8 | 9 | 10 | 11 | 12 | 13 | 14 | 15 | 16 | 17 | 18 |
| Polycarbonate | PC-1 | 20 | — | — | — | 20 | — | — | — | — | — | — | — | — | — | — | — | — | — |
| resin | PC-2 | — | — | 20 | — | — | — | 20 | — | — | — | — | — | — | — | — | — | — | — |
| | PC-3 | — | — | — | — | — | — | — | — | — | 20 | — | 20 | — | — | — | — | — | — |
| | PC-4 | — | — | — | — | — | — | — | — | — | — | — | — | — | — | 20 | 20 | — | — |
| | PC-5 | — | — | — | — | — | — | — | — | — | — | — | — | — | — | — | — | 20 | — |
| | PC-6 | — | — | — | — | — | — | — | — | — | — | — | — | — | — | — | — | — | 20 |
| | PC-7 | — | — | — | — | — | — | — | — | — | — | — | — | — | — | — | — | — | — |
| | PC-8 | — | — | — | — | — | — | — | — | — | — | — | — | — | — | — | — | — | — |
| | PC-9 | — | — | — | — | — | — | — | — | — | — | — | — | — | — | — | — | — | — |
| | PC-10 | — | — | — | — | — | — | — | — | — | — | — | — | — | — | — | — | — | — |
| | PC-11 | — | — | — | — | — | — | — | — | — | — | — | — | — | — | — | — | — | — |
| | PC-12 | — | — | — | — | — | — | — | — | — | — | — | — | — | — | — | — | — | — |
| | PC-13 | — | — | — | — | — | — | — | — | 20 | — | 20 | — | — | — | — | — | — | — |
| | PC-14 | — | 20 | — | — | — | 20 | — | — | — | — | — | — | — | — | — | — | — | — |
| | PC-15 | — | — | — | — | — | — | — | — | — | — | — | — | 20 | 20 | — | — | — | — |
| | PC-16 | — | — | — | 20 | — | — | — | 20 | — | — | — | — | — | — | — | — | — | — |
| | PC-17 | — | — | — | — | — | — | — | — | — | — | — | — | — | — | — | — | — | — |

| | | | | | | | | | | | | | | | | | | |
|---|---|---|---|---|---|---|---|---|---|---|---|---|---|---|---|---|---|---|
| Acrylic compound | — | — | — | — | 20 | 20 | 20 | 20 | — | — | 20 | 20 | — | 20 | — | 20 | — | — |
| Polymerization initiator | — | — | — | — | 1 | 1 | 1 | 1 | — | — | 1 | 1 | — | 1 | — | 1 | — | — |

| | | Example No. | | | | | | | | | | | | | | | | |
|---|---|---|---|---|---|---|---|---|---|---|---|---|---|---|---|---|---|---|
| | | | | | | | | | | | | | | | | | Comparative | Comparative |
| Material | | 19 | 20 | 21 | 22 | 23 | 24 | 25 | 26 | 27 | 28 | 29 | 30 | 31 | 32 | 33 | Example 1 | Example 2 |
| Polycarbonate | PC-1 | — | — | — | — | — | — | — | — | — | — | — | — | — | — | — | — | — |
| resin | PC-2 | — | — | — | — | — | — | — | — | — | — | — | — | — | — | 10 | — | — |
| | PC-3 | — | — | — | — | — | — | — | — | — | — | — | — | — | — | — | — | — |
| | PC-4 | — | — | — | — | — | — | — | — | — | — | — | — | — | — | — | — | — |
| | PC-5 | — | — | — | — | — | — | — | — | — | — | 20 | — | — | — | — | — | — |
| | PC-6 | 20 | — | — | — | — | — | — | — | — | — | — | — | — | — | — | — | — |
| | PC-7 | — | 20 | 20 | — | — | — | — | — | — | — | — | — | — | — | — | — | — |
| | PC-8 | — | — | — | — | — | 20 | 20 | — | — | — | — | — | — | — | — | — | — |
| | PC-9 | — | — | — | — | — | — | — | 20 | — | — | — | — | — | — | — | — | — |
| | PC-10 | — | — | — | — | — | — | — | — | 20 | — | — | — | — | — | — | — | — |
| | PC-11 | — | — | — | — | — | — | — | — | — | 20 | — | — | — | — | — | — | — |
| | PC-12 | — | — | — | 20 | 20 | — | — | — | — | — | — | — | — | — | — | — | — |
| | PC-13 | — | — | — | — | — | — | — | — | — | — | — | — | — | — | — | — | — |
| | PC-14 | — | — | — | — | — | — | — | — | — | — | — | 20 | 20 | — | 10 | — | — |
| | PC-15 | — | — | — | — | — | — | — | — | — | — | — | — | — | 10 | — | — | — |
| | PC-16 | — | — | — | — | — | — | — | — | — | — | — | — | — | 10 | — | — | — |
| | PC-17 | — | — | — | — | — | — | — | — | — | — | — | — | — | — | — | 20 | 20 |

| | | | | | | | | | | | | | | | | | |
|---|---|---|---|---|---|---|---|---|---|---|---|---|---|---|---|---|---|
| Acrylic compound | 20 | — | 20 | — | 20 | — | 20 | — | — | — | 20 | — | — | — | — | 20 | — |
| Polymerization initiator | 1 | — | 1 | — | 1 | — | 1 | — | — | — | 1 | — | — | — | — | 1 | — |

An acrylic compound and a polymerization initiator used were as follows. Acrylic compound:
PO-modified neopentyl glycol diacrylate
(product name: EBECRYL 145; manufactured by Daicel-Allnex Ltd.)
Polymerization initiator:
1-hydroxycyclohexylphenyl ketone
(product name: IRAGACURE 184; manufactured by BASF Corporation)

TABLE 6-1

| Example No. | | 1 | 2 | 3 | 4 | 5 | 6 | 7 | 8 | 9 | 10 | 11 | 12 |
|---|---|---|---|---|---|---|---|---|---|---|---|---|---|
| Evaluation criterion 1 | | D | D | B | A | C | C | S | S | B | C | A | B |
| Evaluation criterion 2 | | C | A | C | C | B | S | B | B | D | B | C | A |
| Volume resistivity | Insulating | 2.8 × | 3.5 × | 2.9 × | 3.0 × | 3.2 × | 4.9 × | 3.2 × | 3.0 × | 2.1 × | 2.9 × | 2.5 × | 3.5 × |
| [Ω · cm] | portion | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ |
| | Conductive | 7.2 × | 6.8 × | 7.0 × | 6.5 × | 6.3 × | 6.9 × | 7.4 × | 7.5 × | 7.2 × | 7.1 × | 7.5 × | 6.8 × |
| | portion | 10⁶ | 10⁶ | 10⁶ | 10⁶ | 10⁶ | 10⁶ | 10⁶ | 10⁶ | 10⁶ | 10⁶ | 10⁶ | 10⁶ |
| Potential | Insulating | 2958 | 4001 | 3000 | 2911 | 3968 | 4301 | 3817 | 4209 | 2415 | 3765 | 2987 | 3914 |
| attenuation time | portion | | | | | | | | | | | | |
| constant [sec] | Conductive | X | X | X | X | X | X | X | X | X | X | X | X |
| | portion | | | | | | | | | | | | |
| Occupancy rate of insulating | | 30 | 28 | 25 | 31 | 32 | 29 | 28 | 27 | 32 | 33 | 34 | 29 |
| portion [%] | | | | | | | | | | | | | |
| Height of insulating portion [μm] | | 5.5 | 4.5 | 5.0 | 5.1 | 6.0 | 5.0 | 5.5 | 5.6 | 5.1 | 4.7 | 5.6 | 5.2 |
| Example No. | | 13 | 14 | 15 | 16 | 17 | 18 | 19 | 20 | 21 | 22 | 23 | 24 |
| Evaluation criterion 1 | | B | A | B | A | S | B | A | C | B | C | B | B |
| Evaluation criterion 2 | | B | A | C | B | D | B | A | C | B | D | C | B |
| Volume resistivity | Insulating | 2.8 × | 3.3 × | 2.6 × | 2.9 × | 2.4 × | 2.9 × | 3.4 × | 2.3 × | 2.5 × | 2.2 × | 2.6 × | 2.7 × |
| [Ω · cm] | portion | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ |
| | Conductive | 6.9 × | 7.4 × | 6.9 × | 7.3 × | 7.5 × | 6.8 × | 7.3 × | 6.7 × | 6.3 × | 6.1 × | 6.3 × | 6.3 × |
| | portion | 10⁶ | 10⁶ | 10⁶ | 10⁶ | 10⁶ | 10⁶ | 10⁶ | 10⁶ | 10⁶ | 10⁶ | 10⁶ | 10⁶ |
| Potential | Insulating | 3689 | 3897 | 2897 | 3590 | 2478 | 2601 | 3609 | 2987 | 2709 | 2390 | 2661 | 2870 |
| attenuation time | portion | | | | | | | | | | | | |
| constant [sec] | Conductive | X | X | X | X | X | X | X | X | X | X | X | X |
| | portion | | | | | | | | | | | | |

| | | | | | | | | | | | | |
|---|---|---|---|---|---|---|---|---|---|---|---|---|
| Occupancy rate of insulating | 28 | 29 | 30 | 31 | 29 | 28 | 31 | 30 | 31 | 29 | 30 | 28 |
| portion [%] | | | | | | | | | | | | |
| Height of insulating portion [μm] | 5.1 | 5.6 | 4.7 | 5.2 | 5.0 | 4.8 | 5.3 | 4.8 | 5.3 | 4.8 | 5.3 | 4.9 |

X: Less than lower limit of measurement

TABLE 6-2

| | | | | | | | | | | | Comparative | Comparative |
|---|---|---|---|---|---|---|---|---|---|---|---|---|
| Example No. | | 25 | 26 | 27 | 28 | 29 | 30 | 31 | 32 | 33 | Example 1 | Example 2 |
| Evaluation criterion 1 | | S | C | C | C | S | D | D | C | D | C | D |
| Evaluation criterion 2 | | S | C | C | D | D | D | S | C | C | E | E |
| Volume | Insulating | 3.7 × | 2.4 × | 2.5 × | 2.2 × | 2.4 × | 2.2 × | 3.9 × | 2.9 × | 3.2 × | 3.0 × | 2.9 × |
| resistivity | portion | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ | 10¹⁴ |
| [Ω · cm] | Conductive | 7.5 × | 6.4 × | 6.4 × | 6.1 × | 7.5 × | 6.1 × | 6.2 × | 7.4 × | 7.0 × | 6.2 × | 6.5 × |
| | portion | 10⁶ | 10⁶ | 10⁶ | 10⁶ | 10⁶ | 10⁶ | 10⁶ | 10⁶ | 10⁶ | 10⁶ | 10⁶ |
| Potential | Insulating | 4290 | 2554 | 2609 | 2309 | 2298 | 2187 | 4289 | 3690 | 3200 | 2087 | 2176 |
| attenuation | portion | | | | | | | | | | | |
| time constant | Conductive | X | X | X | X | X | X | X | X | X | X | X |
| [sec] | portion | | | | | | | | | | | |

| | | | | | | | | | | | |
|---|---|---|---|---|---|---|---|---|---|---|---|
| Occupancy rate of | 33 | 28 | 29 | 30 | 32 | 29 | 30 | 30 | 26 | 32 | 31 |
| insulating portion [%] | | | | | | | | | | | |
| Height of insulating | 5.4 | 5.6 | 5.0 | 5.0 | 5.0 | 15.0 | 0.5 | 5.5 | 5.0 | 6.0 | 5.8 |
| portion [μm] | | | | | | | | | | | |

X: Less than lower limit of measurement

In the table, the insulating portions indicate the first regions, and the conductive portions indicate the second regions.

The occupancy rate of the insulation portions indicates the ratio (occupancy rate RE) of the total area of the first regions in the area of a square observation region with a side length of 900 μm when the square region is placed on the outer surface of the developing roller such that the axis direction of the developing roller and one side of the observation region are parallel.

The height of the insulating portions indicates an average value HD of the height of each of the first regions from the portions in contact with the second regions.

As shown in Tables 6-1 and 6-2, it was found out to be possible to suppress decrease in concentration of the electrophotographic image over a long period of time even in a case where the drive torque between the toner supply roller and the developing roller was reduced and the process speed was further increased by using the developing rollers in Examples 1 to 33. On the other hand, Comparative Examples 1 and 2 resulted in large changes in image concentration.

While the present invention has been described with reference to exemplary embodiments, it is to be understood that the invention is not limited to the disclosed exemplary embodiments. The scope of the following claims is to be accorded the broadest interpretation so as to encompass all such modification and equivalent structures and functions.

This application claims the benefit of Japanese Patent Application No. 2024-064141 filed Apr. 11, 2024, which is hereby incorporated by reference herein its entirety.

What is claimed is:

1. A developing roller comprising:
a substrate that comprises a surface with conductivity; and
a conductive layer on the surface of the substrate,
wherein an outer surface of the developing roller is constituted by at least a first region and a second region that has a higher conductivity than the first region,
the first region and the second region are disposed to be adjacent to each other,
the first region comprises at least one kind of polycarbonate, and
the at least one kind of polycarbonate comprises a structure represented by Formula (1A): 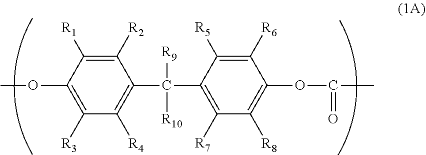
in Formula (1A),
R₁ to R₈ each independently represent a hydrogen atom, an alkyl group having 1 to 9 carbon atoms, or an aryl group having 6 to 10 carbon atoms,
R₉ and R₁₀ each independently represent a hydrogen atom, an alkyl group having 1 to 9 carbon atoms, or an aryl group having 6 to 10 carbon atoms, or
R₉ and R₁₀ are a group of atoms necessary for R₉ and R₁₀ to be bonded to each other to form an alicyclic structure having 6 to 12 carbon atoms,
where (1A) satisfies at least one condition selected from a group consisting of Condition 1 and Condition 2 below:
Condition 1
at least one selected from a group consisting of R₁ to R₈ is the alkyl group having 1 to 9 carbon atoms or the aryl group having 6 to 10 carbon atoms,
Condition 2
at least one selected from a group consisting of R₉ and R₁₀ is a linear or branched alkyl group having 2 or more carbon atoms or the aryl group having 6 to 10 carbon atoms.

2. The developing roller according to claim 1, wherein in Formula (1A), at least one of R₁ and R₃ is an alkyl group having 1 to 9 carbon atoms or an aryl group having 6 to 10 carbon atoms, at least one of R₆ and R₈ is an alkyl group having 1 to 9 carbon atoms or an aryl group having 6 to 10 carbon atoms, and remainders are hydrogen atoms.

3. The developing roller according to claim 1, wherein the at least one kind of polycarbonate comprises at least one structure selected from a group consisting of a structure represented by Structural Formula (2) below and a structure represented by Structural Formula (3) below.

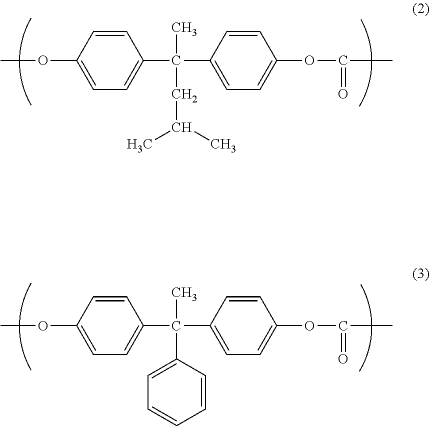

4. The developing roller according to claim 1,
wherein the at least one kind of polycarbonate comprises first polycarbonate and second polycarbonate that comprise mutually different structures,
the first polycarbonate comprises a structure represented by Structural Formula (1) below, and
the second polycarbonate comprises at least one structure selected from a group consisting of a structure represented by Structural Formula (2) below and a structure represented by Structural Formula (3) below:

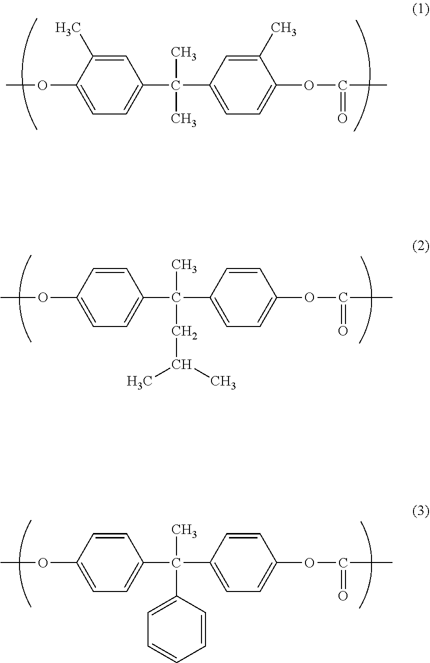

5. The developing roller according to claim 4, wherein the first polycarbonate further comprises a structure represented by Structural Formula (4) below:

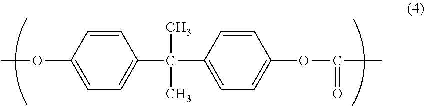

6. The developing roller according to claim 4, wherein the second polycarbonate further comprises a structure represented by Structural Formula (4) below:

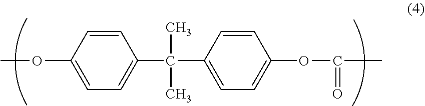

7. The developing roller according to claim 1, wherein a content of the structure represented by Formula (1A) in the at least one kind of polycarbonate is 20 to 100 mol % with reference to all structural units in the polycarbonate.

8. The developing roller according to claim 1, wherein a content of the structure represented by Formula (1A) is 30 to 100 mol % with reference to total resin in the first region.

9. The developing roller according to claim 1, wherein a volume resistivity in the second region is 1.0×10⁵ to 1.0×10¹¹ Ω·cm.

10. The developing roller according to claim 1, wherein a volume resistivity in the first region is 1.0×10¹³ to 1.0×10¹⁸ Ω·cm.

11. The developing roller according to claim 1, wherein a potential attenuation time constant defined as a time required for a potential of a surface in the first region to be attenuated to V₀×(1/e) (V) when the potential of the surface is charged to V₀ (V) is 60.0 seconds or more.

12. The developing roller according to claim 1, wherein a potential attenuation time constant defined as a time required for a potential of a surface in the second region to be attenuated to V₀×(1/e) (V) when the potential of the surface is charged to V₀ (V) is less than 6.0 seconds.

13. The developing roller according to claim 1, wherein when a square observation region with a side length of 900 μm is placed on the outer surface of the developing roller such that an axis direction of the developing roller and one side of the observation region are parallel to each other, a proportion of a total area of the first region in an area of the square region is 10 to 60% by area.

14. The developing roller according to claim 1, wherein the first region further comprises an acrylic resin.

15. A process cartridge configured to be attachable to and detachable from a main body of an electrophotographic image forming apparatus,
the process cartridge comprising, at least: a developing means,
wherein the developing means comprises the developing roller according to claim 1.

16. An electrophotographic image forming apparatus comprising:
a developing means,
wherein the developing means comprises the developing roller according to claim 1.
